(19) United States
(12) Patent Application Publication
(10) Pub. No.: US 2025/0081169 A1
(43) Pub. Date: Mar. 6, 2025

(54) TIME DOMAIN RESOURCE ALLOCATION CONFIGURATION METHOD AND APPARATUS, DEVICE, AND STORAGE MEDIUM

(71) Applicant: GUANGDONG OPPO MOBILE TELECOMMUNICATIONS CORP., LTD., Dongguan (CN)

(72) Inventors: Yi ZHANG, Dongguan (CN); Bin LIANG, Dongguan (CN)

(21) Appl. No.: 18/952,329

(22) Filed: Nov. 19, 2024

Related U.S. Application Data
(63) Continuation of application No. PCT/CN2022/110183, filed on Aug. 24, 2022.

(51) Int. Cl. H04W 72/0446; H04W 72/21

(52) U.S. Cl. CPC H04W 72/0446; H04W 72/21

(57) ABSTRACT

A terminal device and network device are disclosed. The terminal device includes: a processor; and a transceiver coupled with the processor; and a memory for storing an executable program for the processor. The processor is configured to load and execute the executable program to perform an operation of: receiving a configuration of a time domain resource allocation (TDRA) table, wherein the TDRA table is associated with a first object, the first object includes at least two cells, and a TDRA element in the TDRA table includes time domain resource allocation information for data channel corresponding to each cell in the first object.

### CROSS-REFERENCE TO RELATED APPLICATION

This application is a continuation of International Patent Application No. PCT/CN2022/110183 filed on Aug. 4, 2022, the disclosure of which is hereby incorporated by reference in its entirety.

### BACKGROUND

At present, if it is supported that one Downlink Control Information (DCI) schedules a Physical Downlink Shared Channel (PDSCH)/a Physical Uplink Shared Channel (PUSCH) of a plurality of cells, how to indicate the time domain resource allocation of PDSCH/PUSCH of the plurality of cells in the DCI is an urgent technical problem to be solved.

### SUMMARY

Embodiments of the present disclosure provide a terminal device and a network device.

According to an aspect of the present disclosure, there is provided a terminal device. The terminal device includes: a processor; and a transceiver coupled with the processor; and a memory for storing an executable program for the processor. The processor is configured to load and execute the executable program to perform an operation of: receiving a configuration of a time domain resource allocation (TDRA) table, wherein the TDRA table is associated with a first object, the first object comprises at least two cells, and a TDRA element in the TDRA table comprises time domain resource allocation information for data channel corresponding to each cell in the first object.

According to an aspect of the present disclosure, there is provided a network device. The network device, includes a processor; and a transceiver coupled with the processor; and a memory for storing an executable program for the processor; wherein the processor is configured to load and execute the executable program to perform an operation of: transmitting a configuration of a time domain resource allocation (TDRA) table, wherein the TDRA table is associated with a first object, the first object comprises at least two cells, and a TDRA element in the TDRA table comprises time domain resource allocation information for data channel corresponding to each cell in the first object.

### BRIEF DESCRIPTION OF THE DRAWINGS

In order to more clearly illustrate the technical solutions of the embodiments of the disclosure, a brief description of the accompanying drawings required to be used in the embodiments will be provided below. It is apparent that the accompanying drawings of the following description are merely certain embodiments of the disclosure. For a person of ordinary skill in the art, other drawings can also be obtained based on these accompanying drawings without inventive effort.

FIG. 1 illustrates a schematic flow diagram of a method for configuring the time domain resource allocation according to an exemplary embodiment of the present disclosure.

FIG. 2 illustrates a schematic flow diagram of a method for configuring the time domain resource allocation according to an exemplary embodiment of the present disclosure.

FIG. 3 illustrates a schematic flow diagram of a method for configuring the time domain resource allocation according to an exemplary embodiment of the present disclosure.

FIG. 4 illustrates a schematic flow diagram of a method for configuring the time domain resource allocation according to an exemplary embodiment of the present disclosure.

FIG. 5 illustrates a schematic flow diagram of a method for configuring the time domain resource allocation according to an exemplary embodiment of the present disclosure.

FIG. 6 illustrates a schematic flow diagram of a method for configuring the time domain resource allocation according to an exemplary embodiment of the present disclosure.

FIG. 7 illustrates a schematic flow diagram of a method for configuring the time domain resource allocation according to an exemplary embodiment of the present disclosure.

FIG. 8 illustrates a schematic flow diagram of a method for configuring the time domain resource allocation according to an exemplary embodiment of the present disclosure.

FIG. 9 illustrates a structural block diagram of a device for configuring the time domain resource allocation according to an exemplary embodiment of the present disclosure.

FIG. 10 illustrates a structural block diagram of a device for configuring the time domain resource allocation according to an exemplary embodiment of the present disclosure.

FIG. 11 illustrates a structural block diagram of a device for configuring the time domain resource allocation according to an exemplary embodiment of the present disclosure.

FIG. 12 illustrates a structural block diagram of a device for configuring the time domain resource allocation according to an exemplary embodiment of the present disclosure.

FIG. 13 illustrates a schematic structural diagram of an apparatus for configuring the time domain resource allocation according to an exemplary embodiment of the present disclosure.

### DETAILED DESCRIPTION

In order to make the object, technical solution and advantages of the present disclosure clearer, the implementations of the present disclosure will be further described in detail below with reference to the accompanying drawings. Exemplary embodiments, examples of which are illustrated in the accompanying drawings, will be described in detail herein. When the following description refers to the accompanying drawings, same numeral in different accompanying drawings denotes same or similar element, unless otherwise indicated. The implementations described in the following exemplary embodiments do not represent all embodiments consistent with the present disclosure. In contrast, they are merely examples of devices and methods as described in detail in the appended claims and consistent with some aspects of the present disclosure.

The terminologies used in the present disclosure are for the purpose of describing particular embodiments only, and are not intended to limit the present disclosure. As used in the present disclosure and the appended claims, the singular forms “a,” “an” and “the” are intended to include the plural forms as well, unless the context clearly dictates otherwise. It is also to be understood that the term “and/or” as used herein refers to and includes any or all possible combinations of one or more associated listed items.

It is to be understood that although the terms first, second, third, etc. may be employed in the present disclosure to describe various pieces of information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein may be interpreted as “in a case” or “when” or “in response to it is determined”

The related technologies involved in the embodiments of the present disclosure will be introduced firstly.

### 1) Time Domain Resource Assignment/Allocation (TDRA) of PDSCH/PUSCH

In the related art, it is supported that one Downlink Control Information (DCI) schedules one PDSCH or PUSCH, and the DCI includes a TDRA field for indicating the time domain resource allocation of the PDSCH or PUSCH scheduled by the DCI (including slot in which the PDSCH/PUSCH is located, symbols, and mapping type occupied by the PDSCH/PUSCH, etc.). The time domain resource allocation of the PDSCH/PUSCH is specifically determined as follows:

1) A TDRA table is configured for the terminal device through a Radio Resource Control (RRC) parameter (e.g., pdsch-TimeDomainAllocationList/pusch-TimeDomainAllocationList). Alternatively, one or more TDRA tables are agreed for the terminal device by means of protocol agreement. The TDRA table includes one TDRA element or a plurality of TDRA elements, and each TDRA element includes the following parameters:
a slot offset K0/K2, used for determining the slot offset between the slot in which the DCI is located and the slot in which the PDSCH/PUSCH is located;
the start and length indicator (i.e., SLIV) or directly start symbol(S) and allocation length (L), used for determining a starting symbol and a number of symbols occupied by the PDSCH/PUSCH;
a PDSCH/PUSCH mapping type, used for determining the mapping type of the PDSCH/PUSCH;

2) One TDRA element is indicated from the TDRA table configured by the RRC or agreed by the protocol through the TDRA field included in the DCI. For example, the TDRA field value m provides a row index m+1 to the above allocation table.

The relevant signaling for configuring the TDRA table through the RRC parameter (e.g., pdsch-TimeDomainAllocationList/pusch-TimeDomainAllocationList) is as follows:
PDSCH-time domain resource allocation table (PDSCH-TimeDomainResourceAllocationList)

The information element (IE) PDSCH-TimeDomainResourceAllocation is used to configure the TDRA information of PDSCH, including slot, symbols, mapping type occupied by the PDSCH, and the like. The PDSCH-TimeDomainResourceAllocationList contains one or more of such PDSCH-TimeDomainResourceAllocations. The network device indicates in the downlink assignment to which of the time domain resource allocation information elements in the time domain resource allocation table the PDSCH scheduled by the terminal device corresponds. The UE determines the bit width of the DCI field based on the number of entries in the PDSCH-TimeDomainResourceAllocationList. Value 0 in the DCI field refers to the first element in this list, value 1 in the DCI field refers to the second element in this list, and so on.

The IE PDSCH-TimeDomainResourceAllocation is used to configure the TDRA of PDSCH, including at least slot, symbols, mapping type occupied by the PDSCH. The PDSCH-TimeDomainResourceAllocationList contains one or more of such PDSCH-TimeDomainResourceAllocations. The network indicates in the DL assignment which of the configured time domain allocations the UE shall apply for that DL assignment. The UE determines the bit width of the DCI field based on the number of entries in the PDSCH-TimeDomainResourceAllocationList. Value 0 in the DCI field refers to the first element in this list, value 1 in the DCI field refers to the second element in this list, and so on.

•PDSCH-TimeDomainResourceAllocationList information element
PDSCH-TimeDomainResourceAllocationList:: = SEQUENCE (SIZE (1..
maxNrofDL-Allocations)) OF PDSCH-TimeDomainResourceAllocation
PDSCH-TimeDomainResource Allocation:: = SEQUENCE {

| | |
|---|---|
| k0 | INTEGER(0..32) |

OPTIONAL,--Need S

| | |
|---|---|
| mappingType | ENUMERATED {typeA, typeB}, |
| startSymbolAndLength | INTEGER (0..127) |

}

### (2) Single Cell Multi-PDSCH/PUSCH Scheduling

In the work project of “Extending current NR operation to 71 GHz”, in order to support a larger subcarrier spacing, the blind detection period of Physical Downlink Control Channel (PDCCH) is added, and the feature that one DCI schedules a plurality of PDSCHs or PUSCHs in the same cell is supported, and each PDSCH/PUSCH of the plurality of PDSCHs/PUSCHs is used to carry different transport blocks (TB). Some indication fields in the DCI are shared by all PDSCHs, and some indication fields are indicated per PDSCH/PUSCH. Regarding the time domain resource allocation, the function of multi-PUSCH in the NewRadio in Unlicensed Spectrum (NR-U) is multiplexed, herein the TDRA table is extended, and each TDRA element may indicate SLIV, PDSCH/PUSCH mapping type, slot offset K0/K2 of one or more PDSCH/PUSCHs. The configuration signaling is illustrated as follows:

```
PDSCH-TimeDomainResource AllocationList-r17 ::= SEQUENCE (SIZE(1..
maxNrofDL-Allocations)) OF MultiPDSCH-TimeDomainResourceAllocation-r17
MultiPDSCH-TimeDomainResourceAllocation-r17 ::= SEQUENCE {
  pdsch-AllocationList-r17 SEQUENCE
(SIZE(1..maxNrofMultiplePDSCHs-r17)) OF PDSCH-
TimeDomainResourceAllocation-r17,
  ...
}
PDSCH-TimeDomainResourceAllocation-r17 ::= SEQUENCE {
```

| | |
|---|---|
| k0-r17 | INTEGER (0..128) |

OPTIONAL, -- Need S

| | |
|---|---|
| mappingType-r17 | ENUMERATED {typeA, typeB}, |
| startSymbolAndLength-r17 | INTEGER (0..127), |
| repetitionNumber-r17 | ENUMERATED {n2, n3, n4, n5, n6, n7, n8, |

n16} OPTIONAL, -- Cond Formats1-0and1-1
...
}

### (3) Multi-Cell Scheduling

In the work project of “Multi-Carrier”, the feature that one DCI schedules a plurality of PDSCH/PUSCHs of multiple cells is supported, and a plurality of scheduled cells scheduled by one DCI are indicated by the DCI. The specific indication manner needs to be continuously developed in the following options, herein the option 1 is the majority view:

### Agreement:

For multi-cell scheduling, the co-scheduled cells are indicated by DCI format 0_X/1_X. At least the following options are considered:
Option 1: An indicator in the DCI points to one TDRA element of a table (such as a TDRA table) defining combinations of the scheduled cell.

This table is configured by RRC signaling.
Option 2: An indicator in the DCI is a bitmap corresponding to a set of configured cells that can be scheduled by the DCI 0_X/1_X.
Option 3: Using existing fields (e.g., Carrier Indicator Field (CIF), Frequency Domain Resource Allocation (FDRA)) to indicate whether one or more cells are scheduled or not.
Other options are not precluded.

For multi-cell scheduling, the co-scheduled cells are indicated by DCI format 0_X/1_X. At least the following options are considered:
Option 1: An indicator in the DCI points to one row of a table defining combinations of scheduled cells.

The table is configured by RRC signaling.
Option 2: An indicator in the DCI is a bitmap corresponding to a set of configured cells that can be scheduled by the DCI 0_X/1_X.
Option 3: using existing field (e.g., CIF, FDRA) to indicate whether one or more cells are scheduled or not.
Other options are not precluded.

Meanwhile, DCI format 0_X is used to schedule a plurality of PUSCHs on a plurality of cells, and DCI format 1_X is used to schedule a plurality of PDSCHs on a plurality of cells. Further, all scheduled cells scheduled by DCI format 1_X and scheduling cells are included in the same Physical Uplink Control Channel (PUCCH) group, and all scheduled cells scheduled by DCI format 0_X and scheduling cells are included in the same cell group or PUCCH group.

### (4) Cell Group and PUCCH Group

When the terminal device operates in the Dual Connectivity (DC)/Carrier Aggregation (CA) mode, the terminal device may be configured with a Master Cell Group (MCG) and a Secondary Cell Group (SCG) by the network device.

MCG: a group of serving cells including a Master Node (Master Node), the special cell is a Primary Cell (PCell);

SCG: a group of serving cells including a Secondary Node, the special cell is a Primary Secondary cell (PSCell).

In some embodiments, the terminal device cannot feedback the PUCCH on all serving cells in the MCG and the SCG. Assuming that the network device desires to configure at least two serving cells in a cell group (MCG or SCG) as the same PUCCH group, the network device may configure a “pucch-Cell” parameter to some or all of the at least two serving cells, such that the at least two serving cells are classified into the same PUCCH group. Then the cell group (MCG or SCG) is implicitly divided into two PUCCH groups, herein the Hybrid Automatic Repeat Request-Acknowledge (HARQ-ACK) information corresponding to the PDSCH on the cell in one PUCCH group is fedback on the special cell of this cell group, and the HARQ-ACK information corresponding to the PDSCH on the cell in the other PUCCH group is fedback on the configured PUCCH SCell.

The at least two serving cells (corresponding to at least two carriers) belong to the same PUCCH group. Each PUCCH group includes a plurality of serving cells, and specifically includes the following cases.

In the first case, the pucch-Cell parameters of the at least two serving cells are the same.

In the second case, when a first serving cell of the at least two serving cells is the special cell of a cell group to which the first serving cell belongs, a PUCCH cell parameter of any one serving cell of the at least two serving cells other than the first serving cell indicates this special cell; or any one of the at least two serving cells other than the first serving cell is not configured with the pucch-Cell parameter by the network device.

In the third case, the first serving cell of the at least two serving cells is a PUCCH secondary cell, and all the pucch-Cell parameters of other serving cells of the at least two serving cells other than the first serving cell indicate this PUCCH secondary cell.

For example, the MCG includes a primary cell 1, a secondary cell 2, a secondary cell 3, and a secondary cell 4. The network device configures the pucch-cell parameter of the secondary cell 2 as the primary cell 1, the pucch-cell parameter of the secondary cell 4 as the secondary cell 3, and does not configure the pucch-cell parameters of the primary cell 1 and the secondary cell 3, such that it implicitly classifies the primary cell 1 and the secondary cell 2 as one PUCCH group, and classifies the secondary cell 3 and the secondary cell 4 as one PUCCH group.

For another example, the MCG includes a primary cell 1, a secondary cell 2, a secondary cell 3, and a secondary cell 4. The network device configures the pucch-cell parameter of the secondary cell 2 as the primary cell 1, the pucch-cell parameter of the secondary cell 3 as the secondary cell 3, and the pucch-cell parameter of the secondary cell 4 as the secondary cell 3, and implicitly classifies the primary cell 1 and the secondary cell 2 as one PUCCH group, and classifies the secondary cell 3 and the secondary cell 4 as one PUCCH group.

For another example, the MCG includes a primary cell 1, a secondary cell 2, a secondary cell 3, and a secondary cell 4. The network device configures the pucch-cell parameter of the secondary cell 4 as the secondary cell 3. For the primary cell 1, the PUCCH feedback is performed on the primary cell 1 by default. For the secondary cell 2, the pucch-cell parameter is not configured and is not indicated as a PUCCH secondary cell by other pucch-cell parameters, the feedback is performed on the primary cell 1 by default. For the secondary cell 3, the pucch-cell parameter is not configured but is indicated as a PUCCH secondary cell by the pucch-cell parameter of the secondary cell 4, and the feedback is performed on the secondary cell 3. For the secondary cell 4, the pucch-cell parameter is configured and the pucch-cell parameter indicates the secondary cell 3, and the feedback is performed on the secondary cell 3. Thus, the primary cell 1 and the secondary cell 2 are implicitly classified into one PUCCH group, and the secondary cell 3 and the secondary cell 4 are classified into one PUCCH group.

| •PDSCH-ServingCellConfig information element | |
|---|---|
| -- ASN1START | |
| -- TAG-PDSCH-SERVINGCELLCONFIG-START | |
| PDSCH-ServingCellConfig ::= | SEQUENCE { |
| pucch-Cell | ServCellIndex |

```
OPTIONAL, -- Cond SCellAddOnly
  ...,
  [[
• pucch-Cell
```

The ID of the serving cell (of the same cell group) to use for PUCCH. If the field is absent, the UE sends the HARQ feedback on the PUCCH of the SpCell of this cell group, or on this serving cell if it is a PUCCH SCell.

That is, pucch-Cell is the identity of the serving cell (in the same cell group) used for the PUCCH. If the pucch-Cell field is absent, the UE transmits the HARQ feedback on the PUCCH of the special cell of this cell group. If the serving cell is a PUCCH SCell, the HARQ feedback is transmitted on this serving cell.

As can be seen from the above, when considering the feature that one DCI schedules a plurality of PDSCHs/PUSCHs of a plurality of cells is supported, it is natural that the indication of time domain resource allocations of the PDSCHs/PUSCHs of a plurality of cells needs to be included in the DCI, and thus whether the indication of time domain resource allocations of the plurality of PDSCHs/PUSCHs share one indication field or have independent indication fields, and how to perform the indication are issues that are still needed to be discussed.

The present disclosure focuses on time domain resource allocation indication of a plurality of PDSCHs/PUSCHs, and provides a time domain resource allocation indication method, which includes the configuration of a TDRA table and a TDRA indication manner.

In the scenario that one DCI schedules a plurality of PDSCHs/PUSCHs of a plurality of cells, the configuration of the TDRA table may continue the design idea of “Single Cell Multi-PDSCH/PUSCH scheduling” in the related art. That is, the TDRA table in the related art may be extended, and each TDRA element may indicate the SLIV, PDSCH/PUSCH mapping type, and slot offset K0/K2 of the PDSCH/PUSCH on one or more cells. However, the difference lies in that: in the related art, the time domain resource allocation information scheduling of the multi-PDSCH/PUSCH is only for the same cell, so that it is sufficient that the configuration of the extended TDRA table in the related art is for each cell/each BWP in each cell, while in the present disclosure, the time domain resource allocation information scheduling of the multi-PDSCH/PUSCH is for a plurality of cells. It can be seen from the related art that before the terminal device receives the DCI, the terminal device does not known which cell sets are scheduled (since a plurality of scheduled cells scheduled by one DCI are indicated by the DCI itself), as such, in the scenario that one DCI schedules a plurality of PDSCHs/PUSCHs of a plurality of cells, if the configuration of the extended TDRA table is followed, how many PDSCH/PUSCH of which the TDRAs are included in each TDRA element in the extended TDRA table, and to which cells the TDRAs correspond respectively, are problems to be studied.

The technical solution provided by the embodiments of the present disclosure can be applied to various communication systems, for example, a Global System of Mobile communication (GSM) system, a Code Division Multiple Access (CDMA) system, and a Wideband Code Division Multiple Access (WCDMA) system, General Packet Radio Service (GPRS), Long Term Evolution (LTE) system, LTE Frequency Division Duplex (FDD) System, LTE Time Division Duplex (TDD) system, Advanced Long Term Evolution (LTE-A) system, Universal Mobile Telecommunication System (UMTS), Worldwide Interoperability for Microwave Access (WiMAX) communication system, 5th Generation (5G) mobile communication system, New Radio (NR) system, evolution of NR system, LTE-based access to unlicensed spectrum (LTE-U) System, NR-based access to unlicensed spectrum (NR-U) system, Non-Terrestrial Networks (NTN) system, Wireless Local Area Networks (WLAN), Wireless Fidelity (Wi-Fi), cellular Internet of Things system, and cellular passive Internet of Things system, can also be applied to subsequent evolution systems of 5G NR system, and can also be applied to Beyond Fifth Generation (B5G), 6G and subsequent evolution systems. In some embodiments of the present disclosure, “NR” may also be referred to as a 5G NR system or a 5G system. The 5G mobile communication system may include a Non-Standalone networking (NSA) and/or a Standalone networking (SA).

The technical solution provided by the embodiments of the present disclosure may also be applied to Machine Type Communication (MTC), Long Term Evolution-Machine (LTE-M), Device to Device (D2D) networks, Machine to Machine (M2M) network, Internet of Things (IoT) network, or other networks. The IoT network may include, for example, Internet of Vehicles. The communication manners in the vehicle networking system are collectively referred to as vehicle to other devices (Vehicle to X, V2X, X may represent anything). For example, the V2X may include: Vehicle to Vehicle (V2V) communication, Vehicle to Infrastructure (V2I) communication, Vehicle to Pedestrian (V2P) communication, Vehicle to Network (V2N) communication, and the like.

Some embodiments of the present disclosure are performed by a terminal device, or User Equipment (UE), an access terminal device, a subscriber unit, a subscriber station, a mobile station, a mobile station, a remote station, a remote terminal device, a mobile device, a user terminal device, a terminal device, a wireless communication device, a user agent, and a user device. The terminal devices include, but are not limited to, a handheld device, a wearable device, a vehicle-mounted device, an Internet of Things device, etc., for example, a mobile phone, a tablet computer, an e-book reader, a laptop portable computer, a desktop computer, a television, a game console, a mobile Internet Device (MID), an Augmented Reality (AR) terminal device, a Virtual Reality (VR) terminal device and a Mixed Reality (MR) terminal device, a wearable device, a handle, an electronic tag, a controller, a wireless terminal device in Industrial Control, a wireless terminal device in Self Driving, a wireless terminal device in Remote Medical, a wireless terminal device in Smart Grid, a wireless terminal device in Transportation Safety, a wireless terminal device in Smart City, a wireless terminal device in Smart Home, a wireless terminal device in Remote Medical Surgery, a cellular phone, a cordless phone, a Session Initiation Protocol (SIP) telephone, a Wireless Local Loop (WLL) station, a Personal Digital Assistant (PDA), a Set Top Box (STB), a Customer Premise Equipment (CPE), etc.

Some embodiments of the present disclosure are performed by a network device. The network device includes, but not limited to, an Evolved Node B (eNB), a Radio Network Controller (RNC), a Node B (NB), a Base Station Controller (BSC), a Base Transceiver Station (BTS), a home base station (e.g., a Home Evolved Node B, or Home Node B, HNB), a Baseband Unit (BBU), an Access Point (AP) in a Wireless Fidelity (Wi-Fi) system, a wireless relay node, a wireless backhaul node, a Transmission Point (TP), or a Transmission and Reception Point (TRP), or the like. The network device may also be a Next Generation Node B (gNB) or a Transmission Point (TRP or TP) in a 5G system, or, one antenna panel or a group of antenna panels (including a plurality of antenna panels) of a base station in a 5G system, or may also be a network node constituting a gNB or a transmission point, such as a baseband unit (BBU) or a Distributed Unit (DU), etc., or a base station in a B5G or 6G communication system.

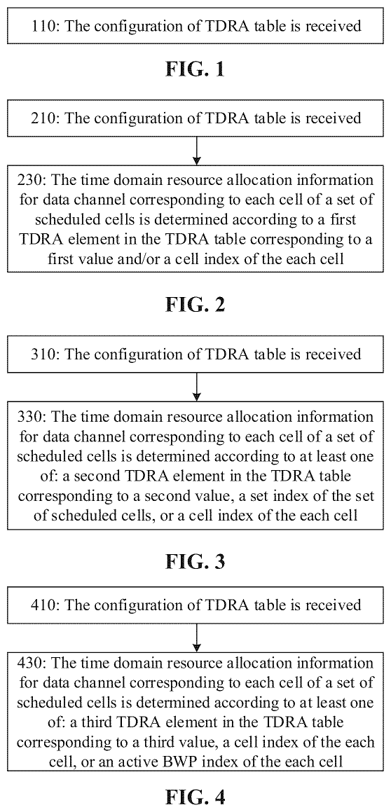

FIG. 1 illustrates a schematic flow diagram of a method for configuring a time domain resource allocation according to an exemplary embodiment of the present disclosure, taking the method being executed by a terminal device as an example, and the method includes at least some of the following steps.

At step 110: the configuration of TDRA table is received.

The configuration may be transmitted by the network device through the higher layer signaling, and the higher layer signaling includes at least one of: a System Information Block (SIB), RRC, or a Medium-Access Control (MAC) signaling.

The TDRA table is associated with or corresponds to a first object, the first object includes at least two cells, and a TDRA element in the TDRA table includes time domain resource allocation information for data channel corresponding to each cell in the first object. The data channel includes at least one type of a PDSCH or a PUSCH. The at least two cells may be scheduled by one DCI, and the DCI schedules the data channels of the at least two cells, such that the case that a plurality of data channels of a plurality of cells are scheduled by one DCI may be implemented.

In some embodiments of the present disclosure, the TDRA table is associated with the first object, and it may also be understood that the TDRA table is configured according to the granularity of the first object. In some embodiments, each TDRA table is configured according to the granularity of the first object; and/or each TDRA element in the TDRA table is configured according to the granularity of the first object, and the first object corresponding to each TDRA element is same or different from each other.

In some embodiments, a TDRA element (also referred to as an entry) may be a TDRA row or a TDRA column. For example, the TDRA element is a TimeDomainResourceAllocation in TimeDomainResourceAllocationList (corresponding to the TDRA table).

In some embodiments, the first object is at least one of:
PUCCH Group;
a cell group; or
a cell set, the cell set is a subset or a universal set of the cell group, or the cell set is a subset or a universal set of the PUCCH group, and it may also be understood that the cell set is a subset or a universal set of cells corresponding to the PUCCH group.

In the present disclosure, the HARQ-ACKs corresponding to the PDSCHs of the cells in the PUCCH group are fed back on the same cell. In some embodiments, the network device configures some or all of the serving cells with a pucch-Cell parameter, divides the MCG into two PUCCH groups (herein the special cell in the MCG is the PCell), and divides the SCG into two PUCCH groups, herein the special cell in the SCG is the PSCell. Then the PUCCH group includes at least one of: a set of cells in the MCG that use the PUCCH of the PCell for performing the feedback, and the HARQ-ACK information corresponding to the PDSCH on the cell in this PUCCH group is fedback on the PCell; or a set of cells in the SCG that use the PUCCH of the PSCell for performing the feedback, and the HARQ-ACK information corresponding to the PDSCH on the cell in this PUCCH group is fedback on the PSCell; or a set of cells in the MCG that use the PUCCH of a same PUCCH SCell for performing the feedback, and the HARQ-ACK information corresponding to the PDSCH on the cell in this PUCCH group is fedback on the same PUCCH SCell; or a set of cells in the SCG that use the PUCCH of a same PUCCH SCell for performing the feedback, and the HARQ-ACK information corresponding to the PDSCH on the cell in this PUCCH group is fedback on the same PUCCH SCell.

In the present disclosure, a cell group refers to a set of serving cells in a group configured by a network device. For example, MCG and SCG.

In the present disclosure, the cell set refers to a scheduling set formed by at least two cells that support being scheduled by one DCI simultaneously, the cell set is a subset or a universal set of the cell group, or the cell set is a subset or a universal set of the PUCCH group, and it may also be understood that the cell set is a subset or a universal set of cells corresponding to the PUCCH group.

In some embodiments, each cell group includes at least one PUCCH group. In some embodiments, each cell group includes at least one cell set.

In some embodiments, the TDRA element in the TDRA table includes the time domain resource allocation information for data channel of each of N cells, N is a number of cells in the first object.

Alternatively, the TDRA element in the TDRA table includes the time domain resource allocation information for data channel of each BWP of each of N cells, and N is a number of cells in the first object.

In some embodiments, each piece of time domain resource allocation information for data channel in the TDRA element corresponds to a cell index of one cell, and this cell is a cell in the first object.

Alternatively, each piece of time domain resource allocation information for data channel in the TDRA element corresponds to a cell index of one cell and one BWP index in this cell, and this cell is a cell in the first object.

In some embodiments, the TDRA table includes: a first TDRA table and/or a second TDRA table. The first TDRA table is used for indicating time domain resource allocation information of PDSCH; and the second TDRA table is used for indicating time domain resource allocation information of PUSCH.

In some embodiments, the configuration case of the TDRA table includes at least one of the following:
the first TDRA table is associated with a PUCCH group;
the second TDRA table is associated with a PUCCH group;
the first TDRA table is associated with a cell group;
the second TDRA table is associated with a cell group;
the first TDRA table is associated with a cell set;
the second TDRA table is associated with a cell set.

In some embodiments, when both the first TDRA table and the second TDRA table are associated with a cell set, the cell set associated with the first TDRA table and the cell set associated with the second TDRA table may be the same or different.

In some embodiments, the TDRA indication information is obtained. The time domain resource allocation information for data channel corresponding to each cell of a set of scheduled cells is determined in the TDRA table based on the TDRA indication information.

In some embodiments, the TDRA indication information is carried in DCI for scheduling a PDSCH, the TDRA table is a first TDRA table, and the first TDRA table is used for indicating time domain resource allocation information of a PDSCH; and/or
the TDRA indication information is carried in a DCI for scheduling a PUSCH, the TDRA table is a second TDRA table, and the second TDRA table is used for indicating time domain resource allocation information of a PUSCH.

As can be seen from the above description, the index corresponding to each piece of time domain resource allocation information for data channel included in the TDRA element can be classified to at least two cases.

Case 1: each piece of time domain resource allocation information for data channel included in the TDRA element corresponds to a cell index of one cell.

Case 2: each piece of time domain resource allocation information for data channel included in the TDRA element corresponds to a cell index of one cell and one BWP index in this cell.

The association between the TDRA table and the first object may also be classified to at least two cases as follows.

Case A: the TDRA table is associated with a PUCCH group and/or a cell group.

Case B: the second TDRA table is associated with a cell set.

In some embodiments, the network device schedules the time domain resource allocation information for data channel corresponding to some or all cells in the first object through the TDRA indication information, and this part or all cells are referred to as a set of scheduled cells.

In some embodiments, the TDRA indication information is used for scheduling at least one piece of time domain resource allocation information for data channel corresponding to some or all of the cells of the at least two cells.

In some embodiments, the TDRA indication information is used for scheduling at least two piece of time domain resource allocation information for data channel corresponding to at least two cells.

Therefore, the operation of determining, in the TDRA table, time domain resource allocation information for data channel corresponding to each cell of a set of scheduled cells based on the TDRA indication information includes at least following four manners.

### Manner 1: Case 1+Case A

That is, each piece of time domain resource allocation information for data channel included in the TDRA element corresponds to a cell index of one cell, and the TDRA table is associated with the PUCCH group and/or the cell group.

In some embodiments, the time domain resource allocation information for data channel corresponding to each cell of a set of scheduled cells is determined according to a first TDRA element in the TDRA table corresponding to a first value and/or a cell index of the each cell.

In some embodiments, the first TDRA element corresponding to the first value is determined in the TDRA table according to the first value. The time domain resource allocation information for data channel corresponding to each cell of the set of scheduled cells is determined in the first TDRA element based on the cell index of the each cell.

### Manner 2: Case 1+Case B

That is, each piece of time domain resource allocation information for data channel included in the TDRA element corresponds to a cell index of one cell, and the TDRA table is associated with the cell set.

In some embodiments, the time domain resource allocation information for data channel corresponding to each cell of a set of scheduled cells is determined according to at least one of: a second TDRA element in the TDRA table corresponding to a second value, a set index of the set of scheduled cells, or a cell index of the each cell.

In some embodiments, the TDRA table is determined according to the set index of the set of the scheduled cells. The second TDRA element corresponding to the second value is determined in the TDRA table according to the second value. The time domain resource allocation information for data channel corresponding to each cell of the set of scheduled cells is determined in the first TDRA element based on the cell index of the each cell.

### Manner 3: Case 2+Case A

That is, each piece of time domain resource allocation information for data channel included in the TDRA element corresponds to a cell index of one cell and one BWP index in this cell, and the TDRA table is associated with the PUCCH group and/or the cell group.

In some embodiments, the time domain resource allocation information for data channel corresponding to each cell of a set of scheduled cells is determined according to at least one of: a third TDRA element in the TDRA table corresponding to a third value, a cell index of the each cell, or an active BWP index of the each cell.

In some embodiments, the third TDRA element corresponding to the third value is determined in the TDRA table according to the third value. The time domain resource allocation information for data channel corresponding to each cell of the set of scheduled cells is determined in the third TDRA element based on the cell index of the each cell and an active BWP index of the each index.

### Manner 4: Case 2+Case B

That is, each piece of time domain resource allocation information for data channel included in the TDRA element corresponds to a cell index of one cell and one BWP index in this cell, and the TDRA table is associated with the cell set.

In some embodiments, the time domain resource allocation information for data channel corresponding to each cell of a set of scheduled cells is determined according to at least one of: a fourth TDRA element in the TDRA table corresponding to a fourth value, a set index of the set of scheduled cells, a cell index of the each cell, or an active BWP index of the each cell.

In some embodiments, the fourth TDRA element corresponding to the fourth value is determined in the TDRA table according to the fourth value. The time domain resource allocation information for data channel corresponding to each cell of the set of scheduled cells is determined in the fourth TDRA element based on the cell index of the each cell and an active BWP index of the each cell.

In some embodiments, the set index and/or the cell index of the set of scheduled cells is carried in a first indication field of the DCI.

In some embodiments, the method provided by the embodiments further includes: transmitting a PDSCH/PUSCH, the time domain position of the PDSCH/PUSCH corresponds to the time domain resource allocation information indicated by TDRA indication information.

In summary, according to the method provided by the embodiments, it is supported that the time domain resource allocation information for data channel of each cell is determined based on the TDRA table flexibly configured. Further, since the configuration of the TDRA table is associated with the first object (including at least two cells), in the scenario that one DCI schedules a plurality of PDSCH/PUSCH of a plurality of cells, the configuration requirements of the TDRA table with different granularities can be met, such that the resource overhead of configuring the TDRA table in the time domain resource allocation process can be saved, and the flexibility and relevance of the configuration and indication in the time domain resource allocation process can be significantly improved.

The embodiments of the above four manners will be then described.

### Manner 1: Case 1+Case A

FIG. 2 illustrates a schematic flow diagram of a method for configuring a time domain resource allocation according to an exemplary embodiment of the present disclosure, taking the method being executed by a terminal device as an example, the method includes at least some of the following steps.

At step 210: the configuration of TDRA table is received.

The configuration may be transmitted by the network device through higher layer signaling, and the higher layer signaling includes SIB, RRC, or MAC signaling.

In some embodiments, the TDRA table is associated with the PUCCH group, the PUCCH group includes at least two cells, and a TDRA element in the TDRA table includes time domain resource allocation information for data channel corresponding to each cell in the PUCCH group. In some embodiments, it may also be understood that the TDRA table is configured at the granularity of the PUCCH group, the PUCCH group includes at least two cells, and each TDRA element in each TDRA table includes the time domain resource allocation information for data channel corresponding to all cells in the PUCCH group.

In some embodiments, the TDRA table is associated with the cell group, the cell group includes at least two cells, and the TDRA element in the TDRA table includes time domain resource allocation information for data channel corresponding to each cell in the cell group. In some embodiments, it may also be understood that the TDRA table is configured at the granularity of the cell group, the cell group includes at least two cells, and each TDRA element in each TDRA table includes the time domain resource allocation information for data channel corresponding to all cells in the cell group.

In some embodiments, the TDRA table is associated with the PUCCH group and the cell group, the PUCCH group and the cell group includes at least two cells, and a TDRA element in the TDRA table includes time domain resource allocation information for data channel corresponding to each cell in the PUCCH group and the cell group. In some embodiments, it may also be understood that the TDRA table is configured at the granularity of the PUCCH group and the cell group, the PUCCH group and the cell group include at least two cells, each TDRA element in the TDRA table associated with the PUCCH group includes the time domain resource allocation information for data channel corresponding to all cells in the PUCCH group, and each TDRA element in the TDRA table associated with the cell group includes the time domain resource allocation information for data channel corresponding to all cells in the cell group.

In some embodiments, the TDRA element in the TDRA table includes the time domain resource allocation information for data channel of each of N cells, N is a number of cells in the PUCCH group and/or the cell group.

In some embodiments, each piece of time domain resource allocation information for data channel in the TDRA element corresponds to a cell index of one cell, and this cell is a cell in the PUCCH group and/or the cell group.

In some embodiments, the TDRA table may include a first TDRA table and/or a second TDRA table. The first TDRA table is used for indicating time domain resource allocation information of a PDSCH, and the second TDRA table is used for indicating time domain resource allocation information of a PUSCH. The TDRA element in the first TDRA table includes N pieces of time domain resource allocation information of PDSCH, and each piece of time domain resource allocation information of PDSCH corresponds to a cell index. The TDRA element in the second TDRA table includes N pieces of time domain resource allocation information of PUSCH, and each piece of time domain resource allocation information of PUSCH corresponds to a cell index.

In some embodiments, the configuration case of the TDRA table includes at least one of the following:
the first TDRA table is associated with a PUCCH group;
the second TDRA table is associated with a PUCCH group;
the first TDRA table is associated with a cell group;
the second TDRA table is associated with a cell group.

In some embodiments, the correspondence between the time domain resource allocation information of PDSCH or the time domain resource allocation information of PUSCH and the cell indexes is predefined through a communication protocol or configured by the network device. For example, the communication protocol predefines that the TDRAs a-b correspond to the cell index p-q, respectively. Alternatively, the network device configures that the TDRA element 1 includes {cell index x, TDRA y}. Exemplarily, the configuration signaling is as follows:

```
PDSCH-TimeDomainResourceAllocationList-r18 ::= SEQUENCE (SIZE(1..
maxNrofDL-Allocations)) OF MultiPDSCH-TimeDomainResourceAllocation-r18
MultiPDSCH-TimeDomainResourceAllocation-r18 ::= SEQUENCE {
  pdsch-AllocationList-r18 SEQUENCE
(SIZE(1..maxNrofMultiplePDSCHs-r17)) OF PDSCH-
TimeDomainResourceAllocation-r18,
  ...
}
PDSCH-TimeDomainResourceAllocation-r18 ::= SEQUENCE {
```

| | |
|---|---|
| Cell-ID | INTEGER(a..b) |

| | |
|---|---|
| k0-r18 | INTEGER (0..128) |

| | |
|---|---|
| OPTIONAL, -- Need S | |
| mappingType-r18 | ENUMERATED {typeA, typeB}, |
| startSymbolAndLength-r18 | INTEGER (0..127), |
| repetitionNumber-r18 | ENUMERATED {n2, n3, n4, n5, n6, n7, n8, |

n16} OPTIONAL, -- Cond Formats1-0and1-1
...
}

In some embodiments, the first TDRA table and the second TDRA table are associated with a PUCCH group.

Alternatively, the first TDRA table is associated with the PUCCH group and the second TDRA table is associated with the cell group.

Alternatively, the first TDRA table and the second TDRA table are associated with the cell group.

In the present embodiment, the description is made by taking the following example: the first TDRA table is associated with a PUCCH group and the second TDRA table is associated with a cell group.

In some embodiments, two cell groups configured by the network device through the RRC signaling are received, namely MCG and SCG, respectively. The MCG and SCG include 16 cells, respectively. The MCG includes two PUCCH groups, denoted as PUCCH group 1 and PUCCH group 2, respectively. The PUCCH group 1 includes 10 cells (such as cell indexes 1-10), and PUCCH group 2 includes 6 cells (e.g. cell indexes 11-16). The SCG includes one PUCCH group, denoted as PUCCH group 3, and the PUCCH group 3 includes 16 cells (such as cell indexes 1-16).

Three first TDRA tables and two second TDRA tables configured by the network device through the RRC signaling are received. Three first TDRA tables are used for indicating the time domain resource allocation information of PDSCH of the PUCCH group 1, the PUCCH group 2, and the PUCCH group 3, respectively. Two second TDRA tables are used for indicating the time domain resource allocation information of PUSCH of the MCG and the SCG, respectively.

The received first TDRA table for PUCCH group 1 is shown in Table 1 below.

TABLE 1
First TDRA table for PUCCH Group 1

| | Cell 1 | Cell 2 | Cell 3 | Cell 4 | Cell 5 | Cell 6 | Cell 7 | Cell 8 | Cell 9 | Cell 10 |
|---|---|---|---|---|---|---|---|---|---|---|
| TDRA | TDRA | TDRA | TDRA | TDRA | TDRA | TDRA | TDRA | TDRA | TDRA | TDRA |
| element 1 | 101 | 102 | 103 | 104 | 105 | 106 | 107 | 108 | 109 | 110 |
| TDRA | TDRA | TDRA | TDRA | TDRA | TDRA | TDRA | TDRA | TDRA | TDRA | TDRA |
| element 2 | 201 | 202 | 203 | 204 | 205 | 206 | 207 | 208 | 209 | 210 |
| TDRA | TDRA | TDRA | TDRA | TDRA | TDRA | TDRA | TDRA | TDRA | TDRA | TDRA |
| element 3 | 301 | 302 | 303 | 304 | 305 | 306 | 307 | 308 | 309 | 310 |

The received first TDRA table for PUCCH group 2 is shown in Table 2 below.

TABLE 2
First TDRA table for PUCCH Group 2

| | Cell 11 | Cell 12 | Cell 13 | Cell 14 | Cell 15 | Cell 16 |
|---|---|---|---|---|---|---|
| TDRA | TDRA | TDRA | TDRA | TDRA | TDRA | TDRA |
| element 1 | 111 | 112 | 113 | 114 | 115 | 116 |
| TDRA | TDRA | TDRA | TDRA | TDRA | TDRA | TDRA |
| element 2 | 211 | 212 | 213 | 214 | 215 | 216 |
| TDRA | TDRA | TDRA | TDRA | TDRA | TDRA | TDRA |
| element 3 | 311 | 312 | 313 | 314 | 315 | 316 |

The received first TDRA table for PUCCH group 3 is shown in Table 3 below.

TABLE 3
First TDRA table for PUCCH Group 3

| | Cell 1 | Cell 2 | Cell 3 | Cell 4 | Cell 5 | Cell 6 | Cell 7 | Cell 8 |
|---|---|---|---|---|---|---|---|---|
| TDRA | TDRA | TDRA | TDRA | TDRA | TDRA | TDRA | TDRA | TDRA |
| element 1 | 101 | 102 | 103 | 104 | 105 | 106 | 107 | 108 |
| TDRA | TDRA | TDRA | TDRA | TDRA | TDRA | TDRA | TDRA | TDRA |
| element 2 | 201 | 202 | 203 | 204 | 205 | 206 | 207 | 208 |
| TDRA | TDRA | TDRA | TDRA | TDRA | TDRA | TDRA | TDRA | TDRA |
| element 3 | 301 | 302 | 303 | 304 | 305 | 306 | 307 | 308 |
| | Cell 9 | Cell 10 | Cell 11 | Cell 12 | Cell 13 | Cell 14 | Cell 15 | Cell 16 |
| TDRA | TDRA | TDRA | TDRA | TDRA | TDRA | TDRA | TDRA | TDRA |
| element 1 | 109 | 110 | 111 | 112 | 113 | 114 | 115 | 116 |
| TDRA | TDRA | TDRA | TDRA | TDRA | TDRA | TDRA | TDRA | TDRA |
| element 2 | 209 | 210 | 211 | 212 | 213 | 214 | 215 | 216 |
| TDRA | TDRA | TDRA | TDRA | TDRA | TDRA | TDRA | TDRA | TDRA |
| element 3 | 309 | 310 | 311 | 312 | 313 | 314 | 315 | 316 |

The received second TDRA table for MCG is shown in Table 4 below:

TABLE 4
Second TDRA table for MCG

| | Cell 1 | Cell 2 | Cell 3 | Cell 4 | Cell 5 | Cell 6 | Cell 7 | Cell 8 |
|---|---|---|---|---|---|---|---|---|
| TDRA | TDRA101 | TDRA102 | TDRA103 | TDRA104 | TDRA105 | TDRA106 | TDRA107 | TDRA108 |
| element 1 | | | | | | | | |
| TDRA | TDRA201 | TDRA202 | TDRA203 | TDRA204 | TDRA205 | TDRA206 | TDRA207 | TDRA208 |
| element 2 | | | | | | | | |
| TDRA | TDRA301 | TDRA302 | TDRA303 | TDRA304 | TDRA305 | TDRA306 | TDRA307 | TDRA308 |
| element 3 | | | | | | | | |
| | Cell 9 | Cell 10 | Cell 11 | Cell 12 | Cell 13 | Cell 14 | Cell 15 | Cell 16 |
| TDRA | TDRA109 | TDRA110 | TDRA111 | TDRA112 | TDRA113 | TDRA114 | TDRA115 | TDRA116 |
| element 1 | | | | | | | | |
| TDRA | TDRA209 | TDRA210 | TDRA211 | TDRA212 | TDRA213 | TDRA214 | TDRA215 | TDRA216 |
| element 2 | | | | | | | | |
| TDRA | TDRA309 | TDRA310 | TDRA311 | TDRA312 | TDRA313 | TDRA314 | TDRA315 | TDRA316 |
| element 3 | | | | | | | | |

The received second TDRA table for SCG is shown in Table 5 below.

TABLE 5
Second TDRA table for SCG

| | Cell 1 | Cell 2 | Cell 3 | Cell 4 | Cell 5 | Cell 6 | Cell 7 | Cell 8 |
|---|---|---|---|---|---|---|---|---|
| TDRA | TDRA | TDRA | TDRA | TDRA | TDRA | TDRA | TDRA | TDRA |
| element 1 | 101 | 102 | 103 | 104 | 105 | 106 | 107 | 108 |
| TDRA | TDRA | TDRA | TDRA | TDRA | TDRA | TDRA | TDRA | TDRA |
| element 2 | 201 | 202 | 203 | 204 | 205 | 206 | 207 | 208 |
| TDRA | TDRA | TDRA | TDRA | TDRA | TDRA | TDRA | TDRA | TDRA |
| element 3 | 301 | 302 | 303 | 304 | 305 | 306 | 307 | 308 |
| | Cell 9 | Cell 10 | Cell 11 | Cell 12 | Cell 13 | Cell 14 | Cell 15 | Cell 16 |
| TDRA | TDRA | TDRA | TDRA | TDRA | TDRA | TDRA | TDRA | TDRA |
| element 1 | 109 | 110 | 111 | 112 | 113 | 114 | 115 | 116 |
| TDRA | TDRA | TDRA | TDRA | TDRA | TDRA | TDRA | TDRA | TDRA |
| element 2 | 209 | 210 | 211 | 212 | 213 | 214 | 215 | 216 |
| TDRA | TDRA | TDRA | TDRA | TDRA | TDRA | TDRA | TDRA | TDRA |
| element 3 | 309 | 310 | 311 | 312 | 313 | 314 | 315 | 316 |

At step 230: the time domain resource allocation information for data channel corresponding to each cell of a set of scheduled cells is determined according to a first TDRA element in the TDRA table corresponding to a first value and/or a cell index of the each cell.

The first value is determined based on the first TDRA indication information. In some embodiments, the first TDRA indication information is transmitted by the network device to the terminal device.

In some embodiments, the first TDRA indication information has a first value.

In some embodiments, the first TDRA indication information is carried in the DCI for scheduling the PDSCH, and/or carried in the DCI for scheduling the PUSCH.

In some embodiments, the cell index of each cell of the set of scheduled cells is explicitly indicated by the network device or implicitly determined based on the set index of the set of scheduled cells. In some embodiments, the cell index is carried in the first indication field of the DCI. In some embodiments, the specific manner of the implicit determination may be predefined through the communication protocol, or configured by the network device.

In some embodiments of the present disclosure, the operation that the cell index is implicitly determined based on the set index means that: there is a correspondence relationship between the set index and the cell index, and after the terminal device obtains the set index, the terminal device may query the cell index in the correspondence relationship according to the set index.

In some embodiments, the set index of the set of scheduled cells is indicated by the network device. In some embodiments, the set index is carried in a first indication field of the DCI.

In some embodiments, the first TDRA element corresponding to the first value is determined in the TDRA table. The time domain resource allocation information for data channel corresponding to each cell is determined based on the first TDRA element.

In some embodiments, the time domain resource allocation information for data channel corresponding to each cell of a set of scheduled cells is determined based on a cell index of the each cell.

In some embodiments, the first TDRA element corresponding to the first value is determined in the TDRA table according to the first value. The time domain resource allocation information for data channel corresponding to each cell of the set of scheduled cells is determined in the first TDRA element based on the cell index of the each cell.

For example, a DCI for scheduling a PDSCH is received, and the DCI carries the first indication information, the first indication information is used for indicating scheduling the PDSCH for cell 1 and cell 5 in PUCCH group 1, and the rows 1 to 16 in the TDRA table correspond to values 0 to 15 in the first indication field one by one, and the first value is 1.

The determination of PDSCH time domain resource allocation information of the cell 1 and the cell 5 is indicated through the following information: when the first value is 1, the second row (TDRA element 2) in the first TDRA table (i.e. Table 1) for the PUCCH group 1 is determined, and the TDRA 201 corresponding to the cell 1 and the TDRA 205 corresponding to the cell 5 are determined in the second row. The terminal device ignores the TDRAs in the second row of Table 1 corresponding to other cell indexes, such as TDRAs 202 to 204 and TDRAs 206 to 210.

In summary, according to the method provided by the present embodiment, the time domain resource allocation information of the data channel of the scheduled cell is determined through a TDRA table configured in association with the PUCCH group and/or the cell group, and each TDRA element in the TDRA table includes the time domain resource allocation information for data channel of all cells in the PUCCH group and/or in the cell group, such that the signaling overhead in the time domain resource allocation process is significantly saved.

### Manner 2: Case 1+Case B

FIG. 3 illustrates a schematic flow diagram of a method for configuring a time domain resource allocation according to an exemplary embodiment of the present disclosure, taking the method being executed by a terminal device as an example, the method includes at least some of the following steps:

At step 310: the configuration of TDRA table is received.

The configuration may be transmitted by the network device through higher layer signaling, and the higher layer signaling includes SIB, RRC, or MAC signaling.

In the present embodiment, the TDRA table is associated with the cell set, the cell set includes at least two cells, and the TDRA element in the TDRA table includes time domain resource allocation information for data channel corresponding to each cell in the cell set. In some embodiments, it may also be understood that the TDRA table is configured at the granularity of the cell set, the cell set includes at least two cells, and each TDRA element in each TDRA table includes the time domain resource allocation information for data channel corresponding to all cells in the cell set.

In some embodiments, the TDRA element in the TDRA table includes the time domain resource allocation information for data channel of each of N cells, N is a number of cells in the cell set.

In some embodiments, each piece of time domain resource allocation information for data channel in the TDRA element corresponds to a cell index of one cell, and this cell is a cell in the cell set.

In some embodiments, the TDRA table may include a first TDRA table and/or a second TDRA table. The first TDRA table is used for indicating time domain resource allocation information of a PDSCH, and the second TDRA table is used for indicating time domain resource allocation information of a PUSCH. The TDRA element in the first TDRA table includes N pieces of time domain resource allocation information of PDSCH, and each piece of time domain resource allocation information of PDSCH corresponds to a cell index. The TDRA element in the second TDRA table includes N pieces of time domain resource allocation information of PUSCH, and each piece of time domain resource allocation information of PUSCH corresponds to a cell index.

In some embodiments, the first TDRA table and the second TDRA table are associated with the cell set. In some embodiments, the cell set associated with the first TDRA table and the cell set associated with the second TDRA table may be the same or different.

In some embodiments, the correspondence between the time domain resource allocation information of PDSCH or the time domain resource allocation information of PUSCH and the cell indexes is predefined through a communication protocol or configured by a network device. For example, the communication protocol predefines that the TDRAs a-b correspond to the cell indexes p-q, respectively. Alternatively, the network device configures that the TDRA element 1 includes {cell index x, TDRA y}.

For example, two cell groups configured by the network device through the RRC signaling are received, namely MCG and SCG, respectively. The MCG and SCG include 16 cells, respectively. The MCG includes two PUCCH groups, denoted as PUCCH group 1 and PUCCH group 2, respectively. The PUCCH group 1 includes 10 cells (such as cell indexes 1-10), and PUCCH group 2 includes 6 cells (e.g. cell indexes 11-16). The SCG includes one PUCCH group, denoted as PUCCH group 3, and the PUCCH group 3 includes 16 cells (such as cell indexes 1-16).

Taking PUCCH group 1 as an example, PUCCH group 1 includes four cell sets, which are:
Cell set 1: Cell 1+Cell 2+Cell 3;
Cell set 2: Cell 4+Cell 5+Cell 6;
Cell set 3: Cell 7+Cell 8;
Cell set 4: Cell 9+Cell 10.

Four first TDRA tables or four second TDRA tables configured by the network device for the PUCCH group 1 through the RRC signaling are received. The four first TDRA tables are used for indicating the time domain resource allocation information of PDSCH of the cell set 1, the cell set 2, the cell set 3, and the cell set 4, respectively, or the four second TDRA tables are used for indicating the time domain resource allocation information of PUSCH of the cell set 1, the cell set 2, the cell set 3, and the cell set 4, respectively. The present embodiment is schematically described by taking that four first TDRA tables are received as an example.

The received first TDRA table for cell set 1 is shown in Table 6 below.

TABLE 6
First TDRA table for cell set 1

| | Cell 1 | Cell 2 | Cell 3 |
|---|---|---|---|
| TDRA element 1 | TDRA 101 | TDRA 102 | TDRA 103 |
| TDRA element 2 | TDRA 201 | TDRA 202 | TDRA 203 |
| TDRA element 3 | TDRA 301 | TDRA 302 | TDRA 303 |

The received first TDRA table for cell set 2 is shown in Table 7 below.

TABLE 7
First TDRA table for cell set 2

| | Cell 4 | Cell 5 | Cell 6 |
|---|---|---|---|
| TDRA element 1 | TDRA 104 | TDRA 105 | TDRA 106 |
| TDRA element 2 | TDRA 204 | TDRA 205 | TDRA 206 |
| TDRA element 3 | TDRA 304 | TDRA 305 | TDRA 306 |

The received first TDRA table for cell set 3 is shown in Table 8 below.

TABLE 8
First TDRA table for cell set 3

| | Cell 7 | Cell 8 |
|---|---|---|
| TDRA element 1 | TDRA 107 | TDRA 108 |
| TDRA element 2 | TDRA 207 | TDRA 208 |
| TDRA element 3 | TDRA 307 | TDRA 308 |

The received first TDRA table for cell set 4 is shown in Table 9 below.

TABLE 9
First TDRA table for cell set 4

| | Cell 9 | Cell 10 |
|---|---|---|
| TDRA element 1 | TDRA 109 | TDRA 110 |
| TDRA element 2 | TDRA 209 | TDRA 210 |
| TDRA element 3 | TDRA 309 | TDRA 310 |

At step 330: the time domain resource allocation information for data channel corresponding to each cell of a set of scheduled cells is determined according to at least one of: a second TDRA element in the TDRA table corresponding to a second value, a set index of the set of scheduled cells, or a cell index of the each cell.

The second value is determined based on the second TDRA indication information. In some embodiments, the second TDRA indication information is transmitted by the network device to the terminal device.

In some embodiments, the second TDRA indication information has a second value.

In some embodiments, the second TDRA indication information is carried in the DCI for scheduling the PDSCH, and/or carried in the DCI for scheduling the PUSCH.

In some embodiments, the cell index of each cell of the set of scheduled cells is explicitly indicated by the network device or implicitly determined based on the set index of the set of scheduled cells. In some embodiments, the cell index is carried in a first indication field of the DCI. In some embodiments, the specific manner of the implicit determination may be predefined through the communication protocol, or configured by the network device.

In some embodiments, the set index of the set of scheduled cells is indicated by the network device. In some embodiments, the set index is carried in a first indication field of the DCI.

In some embodiments, the second TDRA element corresponding to the second value is determined in the TDRA table. The time domain resource allocation information for data channel corresponding to each cell is determined based on the second TDRA element.

In some embodiments, the time domain resource allocation information for data channel corresponding to each cell is determined based on a set index of the set of scheduled cells.

In some embodiments, the time domain resource allocation information for data channel corresponding to each cell of a set of scheduled cells is determined based on a cell index of the each cell.

In some embodiments, the TDRA table is determined according to the set index of the set of the scheduled cells. The second TDRA element corresponding to the second value is determined in the TDRA table according to the second value. The time domain resource allocation information for data channel corresponding to each cell of the set of scheduled cells is determined in the first TDRA element based on the cell index of the each cell.

For example, a DCI for scheduling a PDSCH is received, and the DCI carries the second indication information, the second indication information is used for indicating scheduling the PDSCH for cell group 1 (i.e., cell 1+ cell 2+ cell 3) in PUCCH group 1, and the rows 1 to 16 in the TDRA table correspond to values 0 to 15 in the first indication field one by one, and the second value is 1.

The determination of PDSCH time domain resource allocation information for the cell set 1 is indicated by the following information: the Table 6 is determined according to the cell set 1, the second row (TDRA element 2) in the Table 6 is determined according to the second value being 1, and the TDRA 201 corresponding to the cell 1, the TDRA 202 corresponding to the cell 2, and the TDRA 203 corresponding to the cell 3 are determined in the second row.

In summary, according to the method provided by the present embodiment, the time domain resource allocation information of the scheduled cell is determined through the TDRA table configured in association with the cell set, and each TDRA element in the TDRA table only includes the time domain resource allocation information for data channel of all cells in the set combination, such that the flexibility of the configuration and scheduling during the time domain resource allocation process is significantly improved.

### Manner 3: Case 2+Case A

FIG. 4 illustrates a schematic flow diagram of a method for configuring a time domain resource allocation according to an exemplary embodiment of the present disclosure, taking the method being executed by a terminal device as an example, the method includes at least some of the following steps:

At step 410: the configuration of TDRA table is received.

The configuration may be transmitted by the network device through higher layer signaling, and the higher layer signaling includes SIB, RRC, or MAC signaling.

In some embodiments, the TDRA table is associated with the PUCCH group, the PUCCH group includes at least two cells, and a TDRA element in the TDRA table includes time domain resource allocation information for data channel corresponding to each cell in the PUCCH group. In some embodiments, it may also be understood that the TDRA table is configured at the granularity of the PUCCH group, the PUCCH group includes at least two cells, and each TDRA element in each TDRA table includes the time domain resource allocation information for data channel corresponding to all cells in the PUCCH group.

In some embodiments, the TDRA table is associated with the cell group, the cell group includes at least two cells, and the TDRA element in the TDRA table includes time domain resource allocation information for data channel corresponding to each cell in the cell group. In some embodiments, it may also be understood that the TDRA table is configured at the granularity of the cell group, the cell group includes at least two cells, and each TDRA element in each TDRA table includes the time domain resource allocation information for data channel corresponding to all cells in the cell group.

In some embodiments, the TDRA table is associated with the PUCCH group and the cell group, the PUCCH group and the cell group includes at least two cells, and a TDRA element in the TDRA table includes time domain resource allocation information for data channel corresponding to each cell in the PUCCH group and the cell group. In some embodiments, it may also be understood that the TDRA table is configured at the granularity of the PUCCH group and the cell group, the PUCCH group and the cell group include at least two cells, each TDRA element in the TDRA table associated with the PUCCH group includes the time domain resource allocation information for data channel corresponding to all cells in the PUCCH group, and each TDRA element in the TDRA table associated with the cell group includes the time domain resource allocation information for data channel corresponding to all cells in the cell group.

In some embodiments, the TDRA element in the TDRA table includes the time domain resource allocation information for data channel of each BWP of each of N cells, N is a number of cells in the PUCCH group and/or the cell group. Each TDRA element includes M pieces of time domain resource allocation information for data channel, herein every Bn pieces of time domain resource allocation information for data channel corresponds to one cell index, Bn is the number of uplink BWPs and/or downlink BWPs included in each cell, and ΣBn=M, N=1, 2, . . . . N. That is, each piece of PDSCH or PUSCH time domain resource allocation information corresponds to one cell index and one BWP index, and this cell is a cell in the PUCCH group and/or the cell group.

In some embodiments, the TDRA table may include a first TDRA table and/or a second TDRA table. The first TDRA table is used for indicating time domain resource allocation information of a PDSCH, and the second TDRA table is used for indicating time domain resource allocation information of a PUSCH. The TDRA element in the first TDRA table includes M pieces of time domain resource allocation information of PDSCH, and each piece of time domain resource allocation information of PDSCH corresponds to one cell index and one BWP index. The TDRA element in the second TDRA table includes M pieces of time domain resource allocation information of PUSCH, and each piece of time domain resource allocation information of PUSCH corresponds to one cell index and one BWP index.

In some embodiments, the configuration case of the TDRA table includes at least one of the following:
the first TDRA table is associated with a PUCCH group;
the second TDRA table is associated with a PUCCH group;
the first TDRA table is associated with a cell group;
the second TDRA table is associated with a cell group.

In some embodiments, the first TDRA table and the second TDRA table are associated with a PUCCH group. Alternatively, the first TDRA table is associated with a PUCCH group and the second TDRA table is associated with a cell group. Alternatively, the first TDRA table and the second TDRA table are associated with a cell group.

In the present embodiment, the description is made by taking the following example: the first TDRA table is associated with a PUCCH group and the second TDRA table is associated with a cell group.

In some embodiments, the correspondence between the time domain resource allocation information of PDSCH or the time domain resource allocation information of PUSCH and the cell indexes and BWP indexes is predefined through a communication protocol or configured by a network device. For example, the communication protocol predefines that the TDRAs a-b correspond to the cell indexes p-q, respectively. Alternatively, the network device configures that the TDRA element 1 includes {cell index x, TDRA y}.

For example, two cell groups configured by the network device through the RRC signaling are received, namely MCG and SCG, respectively. The MCG and SCG include 16 cells, respectively. The MCG includes two PUCCH groups, denoted as PUCCH group 1 and PUCCH group 2, respectively. The PUCCH group 1 includes 10 cells (such as cell indexes 1-10), and PUCCH group 2 includes 6 cells (e.g. cell indexes 11-16). The SCG includes one PUCCH group, denoted as PUCCH group 3, and the PUCCH group 3 includes 16 cells (such as cell indexes 1-16).

Each of the above-mentioned cells includes two BWPs. In some embodiments, the number of BWPs included in each cell may be the same or different. The present embodiment is only illustrated schematically by taking an example that each cell includes two BWPs, and does not imply a limitation thereof.

Three first TDRA tables and two second TDRA tables configured by the network device through the RRC signaling are received. The three first TDRA tables are used for indicating the time domain resource allocation information of the PDSCH of the PUCCH group 1, the PUCCH group 2, and the PUCCH group 3, respectively. The two second TDRA tables are used for indicating the time domain resource allocation information of PUSCH of the MCG and the SCG, respectively.

For example, the received first TDRA table for PUCCH group 2 is shown in Table 10 below.

TABLE 10
First TDRA table for PUCCH Group 2

| | Cell 11 | | Cell 12 | | Cell 13 | | Cell 14 | | Cell 15 | | Cell 16 | |
|---|---|---|---|---|---|---|---|---|---|---|---|---|
| | Cell 11 | Cell 11 | Cell 12 | Cell 12 | Cell 13 | Cell 13 | Cell 14 | Cell 14 | Cell 15 | Cell 15 | Cell 16 | Cell 16 |
| | BWP 1 | BWP 2 | BWP 1 | BWP 2 | BWP 1 | BWP 2 | BWP 1 | BWP 2 | BWP 1 | BWP 2 | BWP 1 | BWP 2 |
| TDRA | TDRA | TDRA | TDRA | TDRA | TDRA | TDRA | TDRA | TDRA | TDRA | TDRA | TDRA | TDRA |
| element 1 | 111-1 | 111-2 | 112-1 | 112-2 | 113-1 | 113-2 | 114-1 | 114-2 | 115-1 | 115-2 | 116-1 | 116-2 |
| TDRA | TDRA | TDRA | TDRA | TDRA | TDRA | TDRA | TDRA | TDRA | TDRA | TDRA | TDRA | TDRA |
| element 2 | 211-1 | 211-2 | 212-1 | 212-2 | 213-1 | 213-2 | 214-1 | 214-2 | 215-1 | 215-2 | 216-1 | 216-2 |
| TDRA | TDRA | TDRA | TDRA | TDRA | TDRA | TDRA | TDRA | TDRA | TDRA | TDRA | TDRA | TDRA |
| element 3 | 311-1 | 311-2 | 312-1 | 312-2 | 313-1 | 313-2 | 314-1 | 314-2 | 315-1 | 315-2 | 316-1 | 316-2 |

At step 430: the time domain resource allocation information for data channel corresponding to each cell of a set of scheduled cells is determined according to at least one of: a third TDRA element in the TDRA table corresponding to a third value, a cell index of the each cell, or an active BWP index of the each cell.

The third value is determined based on the third TDRA indication information. In some embodiments, the third TDRA indication information is transmitted by the network device to the terminal device.

In some embodiments, the third TDRA indication information has a third value.

In some embodiments, the third TDRA indication information is carried in the DCI for scheduling the PDSCH, and/or the third TDRA indication information is carried in the DCI for scheduling the PUSCH.

In some embodiments, the cell index of each cell of the set of scheduled cells is explicitly indicated by the network device or implicitly determined based on the set index of the set of scheduled cells. In some embodiments, the cell index is carried in a first indication field of the DCI. In some embodiments, the specific manner of the implicit determination may be predefined through the communication protocol, or configured by the network device.

In some embodiments, the set index of the set of scheduled cells is indicated by the network device. In some embodiments, the set index is carried in a first indication field of the DCI.

In some embodiments, the BWP index in each cell is indicated by the network device. Alternatively, the BWP index in each cell is implicitly determined based on the set index of the set of scheduled cells. Alternatively, the BWP index in each cell is implicitly determined based on the cell index of each cell of the set of scheduled cells. Alternatively, the BWP index in each cell is implicitly determined based on the set index of the set of scheduled cells and the cell index of each cell of the set of scheduled cells. In some embodiments, the BWP index is carried in a first indication field of the DCI. In some embodiments, the specific manner of the implicit determination may be predefined through the communication protocol, or configured by the network device.

In some embodiments, the third TDRA element corresponding to the third value is determined in the TDRA table. The time domain resource allocation information for data channel corresponding to each cell is determined based on the third TDRA element.

In some embodiments, the time domain resource allocation information for data channel corresponding to each cell of a set of scheduled cells is determined based on a cell index of the each cell.

In some embodiments, the time domain resource allocation information for data channel corresponding to each cell of a set of scheduled cells is determined based on a BWP index of the each cell.

In some embodiments, the third TDRA element corresponding to the third value is determined in the TDRA table. The time domain resource allocation information for data channel corresponding to each cell of the set of scheduled cells is determined in the third TDRA element based on the cell index of the each cell.

In some embodiments, the third TDRA element corresponding to the third value is determined in the TDRA table according to the third value. The time domain resource allocation information for data channel corresponding to each cell of the set of scheduled cells is determined in the third TDRA element based on the cell index of the each cell and an active BWP index of the each index.

For example, a DCI for scheduling the PDSCH is received, and the DCI carries the third indication information, the third indication is used for indicating scheduling the PDSCH of the cell 11 BWP2 and the cell 13 BWP2 in the PUCCH group 2, or indicating scheduling the PDSCH of the cell 11 and the cell 13 in the PUCCH group 2, and both the active BWP index of the cell 11 and the active BWP of the cell 13 are 2. The first to the sixteenth rows in the TDRA table correspond to values 0 to 15 in the first indication field one by one, and the third value is 2.

The determination of PDSCH time domain resource allocation information of the cell 11 BWP2 and the cell 13 BWP2 is indicated through the following information: the third row (TDRA element 3) in the first TDRA table (i.e. Table 10) for the PUCCH group 2 is determined according to the first value being 1, and the TDRA 311-2 corresponding to the cell 11 BWP2 and the TDRA 313-2 corresponding to the cell 13 BWP2 are determined in the third row. The terminal device ignores the TDRAs corresponding to other cell indexes and BWP indexes in the third row of Table 10.

In summary, according to the method provided by the present embodiment, by means of a TDRA table configured in association with the PUCCH group and/or the cell group, and considering the case that each cell includes a plurality of BWPs, each TDRA element in the TDRA table includes the time domain resource allocation information for data channel of all cells in all PUCCH groups and/or in all cell groups and the BWPs of the cells, such that the signaling overhead during the time domain resource allocation process is significantly saved, and the flexibility of the configuration and scheduling during the time domain resource allocation process is further improved.

### Manner 4: Case 2+Case B

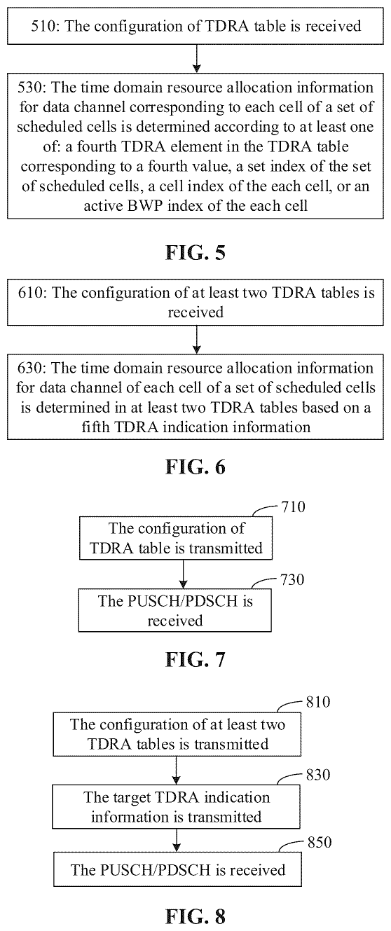

FIG. 5 illustrates a schematic flow diagram of a method for configuring a time domain resource allocation according to an exemplary embodiment of the present disclosure, taking the method being executed by a terminal device as an example, the method includes at least some of the following steps:

At step 510: the configuration of TDRA table is received.

The configuration may be transmitted by the network device through higher layer signaling, and the higher layer signaling includes SIB, RRC, or MAC signaling.

In the present embodiment, the TDRA table is associated with the cell set, the cell set includes at least two cells, and the TDRA element in the TDRA table includes time domain resource allocation information for data channel corresponding to each cell in the cell set. In some embodiments, it may also be understood that the TDRA table is configured at the granularity of the cell set, the cell set includes at least two cells, and each TDRA element in each TDRA table includes the time domain resource allocation information for data channel corresponding to all cells in the cell set.

In some embodiments, the TDRA element in the TDRA table includes the time domain resource allocation information for data channel of each BWP of each of N cells, N is a number of cells in the cell set. Each TDRA element includes M pieces of time domain resource allocation information for data channel, herein every Bn pieces of time domain resource allocation information for data channel corresponds to one cell index, Bn is the number of uplink BWPs and/or downlink BWPs included in each cell, and ΣBn=M, N=1, 2, . . . . N. That is, each piece of PDSCH or PUSCH time domain resource allocation information corresponds to one cell index and one BWP index, and this cell is a cell in the cell set.

In some embodiments, the TDRA table may include a first TDRA table and/or a second TDRA table. The first TDRA table is used for indicating time domain resource allocation information of a PDSCH, and the second TDRA table is used for indicating time domain resource allocation information of a PUSCH. The TDRA element in the first TDRA table includes M pieces of time domain resource allocation information of PDSCH, and each piece of time domain resource allocation information of PDSCH corresponds to one cell index and one BWP index. The TDRA element in the second TDRA table includes M pieces of time domain resource allocation information of PUSCH, and each piece of time domain resource allocation information of PUSCH corresponds to one cell index and one BWP index.

In some embodiments, the first TDRA table and the second TDRA table are associated with the cell set. In some embodiments, the cell set associated with the first TDRA table and the cell set associated with the second TDRA table may be the same or different.

In some embodiments, the correspondence between the time domain resource allocation information of PDSCH or the time domain resource allocation information of PUSCH and the cell indexes and BWP indexes is predefined through a communication protocol or configured by a network device. For example, the communication protocol predefines that the TDRAs a-b correspond to the cell indexes p-q, respectively. Alternatively, the network device configures that the TDRA element 1 includes {cell index x, TDRA y}.

For example, two cell groups configured by the network device through the RRC signaling are received, namely MCG and SCG, respectively. The MCG and SCG include 16 cells, respectively. The MCG includes two PUCCH groups, denoted as PUCCH group 1 and PUCCH group 2, respectively. The PUCCH group 1 includes 10 cells (such as cell indexes 1-10), and PUCCH group 2 includes 6 cells (e.g. cell indexes 11-16). The SCG includes one PUCCH group, denoted as PUCCH group 3, and the PUCCH group 3 includes 16 cells (such as cell indexes 1-16).

Taking PUCCH group 1 as an example, PUCCH group 1 includes four cell sets, which are:
Cell set 1: Cell 1+Cell 2+Cell 3;
Cell set 2: Cell 4+Cell 5+Cell 6;
Cell set 3: Cell 7+Cell 8;
Cell set 4: Cell 9+Cell 10.

Each of the above-mentioned cells includes two BWPs. In some embodiments, the number of BWPs included in each cell may be the same or different. The present embodiment is only illustrated schematically by taking an example that each cell includes two BWPs, and does not imply a limitation thereof.

Four first TDRA tables or four second TDRA tables configured by the network device for the PUCCH group 1 through the RRC signaling are received. The four first TDRA tables are used for indicating the time domain resource allocation information of the PDSCH of the cell set 1, the cell set 2, the cell set 3, and the cell set 4, respectively, or the four second TDRA tables are used for indicating the time domain resource allocation information of the PUSCH of the cell set 1, the cell set 2, the cell set 3, and the cell set 4, respectively. The present embodiment is schematically described by taking that four first TDRA tables are received as an example.

For example, the received first TDRA table for cell set 3 is shown in Table 11 below.

TABLE 11
First TDRA table for cell set 3

| | Cell 7 | | Cell 8 | |
|---|---|---|---|---|
| | Cell 7 BWP 1 | Cell 7 BWP 2 | Cell 8 BWP 1 | Cell 8 BWP 2 |
| TDRA element 1 | TDRA 107-1 | TDRA 107-2 | TDRA 108-1 | TDRA 108-2 |
| TDRA element 2 | TDRA 207-1 | TDRA 207-2 | TDRA 208-1 | TDRA 208-2 |
| TDRA element 3 | TDRA 307-1 | TDRA 307-2 | TDRA 308-1 | TDRA 308-2 |

At step 530: the time domain resource allocation information for data channel corresponding to each cell of a set of scheduled cells is determined according to at least one of: a fourth TDRA element in the TDRA table corresponding to a fourth value, a set index of the set of scheduled cells, a cell index of the each cell, or an active BWP index of the each cell.

The fourth value is determined based on the fourth TDRA indication information. In some embodiments, the fourth TDRA indication information is transmitted by the network device to the terminal device.

In some embodiments, the fourth TDRA indication information has a fourth value.

In some embodiments, the fourth TDRA indication information is carried in the DCI for scheduling the PDSCH, and/or the fourth TDRA indication information is carried in the DCI for scheduling the PUSCH.

In some embodiments, the cell index of each cell of the set of scheduled cells is explicitly indicated by the network device, or implicitly determined based on the set index of the set of scheduled cells. In some embodiments, the cell index is carried in a first indication field of the DCI. In some embodiments, the specific manner of the implicit determination may be predefined through the communication protocol, or configured by the network device.

In some embodiments, the set index of the set of scheduled cells is indicated by the network device. In some embodiments, the set index is carried in a first indication field of the DCI.

In some embodiments, the BWP index in each cell is indicated by the network device. Alternatively, the BWP index in each cell is implicitly determined based on the set index of the set of scheduled cells. Alternatively, the BWP index in each cell is implicitly determined based on the cell index of each cell of the set of scheduled cells. Alternatively, the BWP index in each cell is implicitly determined based on the set index of the set of scheduled cells and the cell index of each cell of the set of scheduled cells. In some embodiments, the BWP index is carried in a first indication field of the DCI. In some embodiments, the specific manner of the implicit determination may be predefined through the communication protocol, or configured by the network device.

In some embodiments, the fourth TDRA element corresponding to the fourth value is determined in the TDRA table. The time domain resource allocation information for data channel corresponding to each cell is determined based on the fourth TDRA element.

In some embodiments, the time domain resource allocation information for data channel corresponding to each cell of a set of scheduled cells is determined based on a cell index of the each cell.

In some embodiments, the time domain resource allocation information for data channel corresponding to each cell of a set of scheduled cells is determined based on a BWP index of the each cell.

In some embodiments, the fourth TDRA element corresponding to the fourth value is determined in the TDRA table. The time domain resource allocation information for data channel corresponding to each cell of the set of scheduled cells is determined in the fourth TDRA element based on the cell index of the each cell.

In some embodiments, the fourth TDRA element corresponding to the fourth value is determined in the TDRA table according to the fourth value. The time domain resource allocation information for data channel corresponding to each cell of the set of scheduled cells is determined in the fourth TDRA element based on the cell index of the each cell and an active BWP index of the each index.

For example, a DCI for scheduling the PDSCH is received, and the DCI carries the fourth indication information, the fourth indication is used for indicating scheduling the PDSCH of BWP2 in cell set 3 in the PUCCH group 1 (i.e., cell 7 BWP2+cell 8 BWP2), or the fourth indication is used for indicating scheduling the PDSCH of the cell 7 and the cell 8 in the PUCCH group 1, and both the active BWP index of the cell 7 and the active BWP of the cell 8 are 2. The first to the sixteenth rows in the TDRA table correspond to values 0 to 15 in the first indication field one by one, and the third value is 2.

The determination of PDSCH time domain resource allocation information for the cell set 3 is indicated by the following information: the table 11 is determined according to the cell set 3, the third row (TDRA element 3) in the table 11 is determined according to the fourth value being 2, and the TDRA 307-2 corresponding to the cell 7 and the TDRA 308-2 corresponding to the cell 8 are determined in the third row. The terminal device ignores the TDRAs in the third row of Table 9 corresponding to other BWP indexes, such as TDRA 307-1 and TDRA 308-1.

In summary, according to the method provided by the present embodiment, by means of a TDRA table configured in association with the cell set, and considering the case that each cell includes a plurality of different BWPs, each TDRA element in the TDRA table includes the time domain resource allocation information for data channel of all cells in the cell set and the BWPs of the cells, such that the configuration and scheduling during the time domain resource allocation process is further improved.

FIG. 6 illustrates a schematic flow diagram of a method for configuring a time domain resource allocation according to an exemplary embodiment of the present disclosure, taking the method being executed by a terminal device as an example, the method includes at least some of the following steps:

At step 610: the configuration of at least two TDRA tables is received.

The configuration may be transmitted by the network device through higher layer signaling, and the higher layer signaling includes SIB, RRC, or MAC signaling.

In the present embodiment, the TDRA table is associated with the BWP of each cell, and the TDRA element in the TDRA table includes time domain resource allocation information for data channel of one cell. In some embodiments, the TDRA element in the TDRA table includes the time domain resource allocation information for data channel of one BWP of one cell. The TDRA table includes at least one TDRA element.

In the present embodiments, it is illustratively described with the example that the TDRA table includes a first TDRA table and a second TDRA table. The first TDRA table is used for indicating the time domain resource allocation information of PDSCH, and the second TDRA table is used for indicating the time domain resource allocation information of PUSCH. Each TDRA element in the first TDRA table includes one piece of time domain resource allocation information of PDSCH, and each piece of time domain resource allocation information of PDSCH corresponds to one cell index and one BWP index. Each TDRA element in the second TDRA table includes one piece of time domain resource allocation information of PUSCH, and each piece of time domain resource allocation information of PUSCH corresponds to one cell index and one BWP index.

In some embodiments, the correspondence between the time domain resource allocation information of PDSCH or the time domain resource allocation information of PUSCH and the cell indexes and BWP indexes is predefined through a communication protocol or configured by a network device. For example, the communication protocol predefines that the TDRAs a-b correspond to the cell indexes p-q and BWP indexes 1-3, respectively. Alternatively, the network device configures that the TDRA element 1 includes {cell index x BWP index z, TDRA y}.

For example, 16 cells (e.g., cell indexes 1 to 16) configured by the network device through RRC signaling are received, and each cell includes 4 BWPs (e.g., BWP indexes 1 to 4).

64 (16×4) first TDRA tables configured by the network device through RRC signaling are received, and each first TDRA table includes 16 TDRA elements (TDRA element indexes are 1 to 16).

For example, the received first TDRA table for cell 1 BWP1 is shown in Table 12 below.

TABLE 12
First TDRA table for cell 1 BWP1

| | Cell 1 BWP 1 |
|---|---|
| TDRA element 1 | TDRA 101-1 |
| TDRA element 2 | TDRA 201-1 |
| TDRA element 3 | TDRA 301-1 |

. . .

| | |
|---|---|
| TDRA element 16 | TDRA 1601-1 |

The received first TDRA table for cell 1 BWP2 is shown in Table 13 below.

TABLE 13
First TDRA table for cell 1 BWP2

| | Cell 1 BWP 2 |
|---|---|
| TDRA element 1 | TDRA 101-2 |
| TDRA element 2 | TDRA 201-2 |
| TDRA element 3 | TDRA 301-2 |

. . .

| | |
|---|---|
| TDRA element 16 | TDRA 1601-2 |

The received first TDRA table for cell 1 BWP3 is shown in Table 14 below.

TABLE 14
First TDRA table for cell 1 BWP3

| | Cell 1 BWP 3 |
|---|---|
| TDRA element 1 | TDRA 101-3 |
| TDRA element 2 | TDRA 201-3 |
| TDRA element 3 | TDRA 301-3 |

. . .

| | |
|---|---|
| TDRA element 16 | TDRA 1601-3 |

The received first TDRA table for cell 1 BWP4 is shown in Table 15 below.

TABLE 15
First TDRA table for cell 1 BWP4

| | Cell 1 BWP4 |
|---|---|
| TDRA element 1 | TDRA 101-4 |
| TDRA element 2 | TDRA 201-4 |
| TDRA element 3 | TDRA 301-4 |

. . .

| | |
|---|---|
| TDRA element 16 | TDRA 1601-4 |

The received first TDRA table for cell 2 BWP1 is shown in Table 16 below.

TABLE 16
First TDRA table for cell 2 BWP1

| | Cell 2 BWP1 |
|---|---|
| TDRA element 1 | TDRA 102-1 |
| TDRA element 2 | TDRA 202-1 |
| TDRA element 3 | TDRA 302-1 |

. . .

| | |
|---|---|
| TDRA element 16 | TDRA 1602-1 |

The received first TDRA table for cell 2 BWP2 is shown in Table 17 below.

TABLE 17
First TDRA table for cell 2 BWP2

| | Cell 2 BWP2 |
|---|---|
| TDRA element 1 | TDRA 102-2 |
| TDRA element 2 | TDRA 202-2 |
| TDRA element 3 | TDRA 302-2 |

. . .

| | |
|---|---|
| TDRA element 16 | TDRA 1602-2 |

The configuration of the first TDRA tables corresponding to other cell indexes and the BWP indexes is in a similar manner.

At step 630: the time domain resource allocation information for data channel of each cell of a set of scheduled cells is determined in at least two TDRA tables based on the target TDRA indication information.

The scheduled cells include at least two cells, and the at least two cells are at least two of the serving cells.

The target indication information is transmitted by the network device to the terminal device. In some embodiments, the target indication information is carried in the DCI for scheduling the PDSCH, and/or the target indication information is carried in the DCI for scheduling the PUSCH.

In some embodiments, the target value is determined based on the target indication information. In some embodiments, the target indication information has a target value.

In some embodiments, the target value is used for indicating the TDRA element with an element index of n in all received TDRA tables. In some embodiments, the correspondence relationship between the target value and n is configured by the network device through the higher layer signaling, or predefined through the communication protocol. In some embodiments, the correspondence relationship between the target values of different cells or different BWPs and n may be the same or different. For example, the target value is m, which indicates that the n-th row of TDRA elements in the received 64 first TDRA tables, n=m or n=m+1.

In some embodiments, the cell index of each cell of the set of scheduled cells is explicitly indicated by the network device or implicitly determined based on the set index of the set of scheduled cells. In some embodiments, the cell index is carried in a first indication field of the DCI. In some embodiments, the specific manner of the implicit determination may be predefined through the communication protocol, or configured by the network device.

In some embodiments, the set index of the set of scheduled cells is indicated by the network device. In some embodiments, the set index is carried in a first indication field of the DCI.

In some embodiments, the BWP index in each cell is indicated by the network device. Alternatively, the BWP index in each cell is implicitly determined based on the set index of the set of scheduled cells. Alternatively, the BWP index in each cell is implicitly determined based on the cell index of each cell of the set of scheduled cells. Alternatively, the BWP index in each cell is implicitly determined based on the set index of the set of scheduled cells and the cell index of each cell of the set of scheduled cells. In some embodiments, the BWP index is carried in a first indication field of the DCI. In some embodiments, the specific manner of the implicit determination may be predefined through the communication protocol, or configured by the network device.

In some embodiments, the set of first TDRA tables is determined in the at least two received TDRA tables. The target TDRA element corresponding to the target TDRA indication information and/or the target value is determined in the set of first TDRA tables. The time domain resource allocation information for data channel corresponding to each cell is determined based on the target TDRA element.

In some embodiments, the time domain resource allocation information for data channel corresponding to each cell of a set of scheduled cells is determined based on a cell index of the each cell.

In some embodiments, the time domain resource allocation information for data channel corresponding to each cell of a set of scheduled cells is determined based on a BWP index of the each cell.

In some embodiments, the set of first TDRA tables is determined in the at least two received TDRA tables according to the cell index and the active BWP index of each cell of the set of scheduled cells. The target TDRA element corresponding to the target TDRA indication information and/or the target value is determined in the set of first TDRA tables. The time domain resource allocation information for data channel corresponding to the BWP of each cell is determined in the target TDRA element in the determined set of first TDRA tables. The first set of TDRA tables includes a TDRA table corresponding to a set of scheduled cells in the at least two TDRA tables.

For example, a DCI for scheduling the PDSCH is received, and the DCI carries the target indication information, the target indication information is used for indicating scheduling the PDSCH of the cell 1 BWP2 and the PDSCH of the cell 2 BWP2, or indicating scheduling the PDSCH of cell 1 and the PDSCH of cell 2, and both the active BWP index of the cell 1 and the active BWP of the cell 2 are 2. The first to the sixteenth rows in the TDRA table correspond to values 0 to 15 in the first indication field one by one, and the target value is 2.

The determination of the time domain resource allocation information of PDSCH of the cell 1 BWP2 and the cell 2 BWP2 is indicated by the following information: Table 13 and Table 17 are determined according to the cell 1 BWP2 and the cell 2 BWP2, respectively, the third row (TDRA element 3) is determined in Table 13 and Table 17 according to the target value of 2, the TDRA 301-2 corresponding to the active BWP of the cell 1 is determined in the third row of Table 13, and the TDRA 302-2 corresponding to the active BWP of the cell 2 is determined in the third row of Table 17.

In some embodiments, the method provided by the embodiments further includes: transmitting a PDSCH/PUSCH, the time domain position of the PDSCH/PUSCH corresponds to the time domain resource allocation information indicated by the target TDRA indication information.

In summary, according to the method provided in the present embodiment, based on the TDRA table configured in association with the BWP of each cell, the scheduled cell and the active BWP are determined, and the corresponding TDRA element is determined in the corresponding TDRA table based on the TDRA indication information, such that the accuracy and flexibility of the configuration and scheduling in the time domain resource allocation process are improved.

FIG. 7 illustrates a schematic flow diagram of a method for configuring a time domain resource allocation according to an exemplary embodiment of the present disclosure, taking the method being executed by a network device as an example, and method includes at least some of the following steps.

At step 710: the configuration of TDRA table is transmitted.

The configuration may be transmitted by the network device through higher layer signaling, and the higher layer signaling includes SIB, RRC, or MAC signaling.

The TDRA table is associated with or corresponds to a first object, the first object includes at least two cells, and a TDRA element in the TDRA table includes time domain resource allocation information for data channel corresponding to each cell in the first object. The data channel includes at least one of a PDSCH or a PUSCH.

In some embodiments, the TDRA element is a TDRA row or a TDRA column. For example, the TDRA element is a Time DomainResourceAllocation in TimeDomainResourceAllocationList.

In some embodiments, the first object is at least one of:
PUCCH Group;
a cell group; or
a cell set, the cell set is a subset or a universal set of the cell group, or the cell set is a subset or a universal set of the PUCCH group, and it may also be understood that the cell set is a subset or a universal set of cells corresponding to the PUCCH group.

In some embodiments, each cell group includes at least one PUCCH group.

In some embodiments, each cell group includes at least one cell set.

In some embodiments, the TDRA element in the TDRA table includes the time domain resource allocation information for data channel of each of N cells, N is a number of cells in the first object.

Alternatively, the TDRA element in the TDRA table includes the time domain resource allocation information for data channel of each BWP of each of N cells, and N is a number of cells in the first object.

In some embodiments, each piece of time domain resource allocation information for data channel in the TDRA element corresponds to a cell index of one cell, and this cell is a cell in the first object.

Alternatively, each piece of time domain resource allocation information for data channel in the TDRA element corresponds to a cell index of one cell and one BWP index in this cell, and this cell is a cell in the first object.

In some embodiments, the TDRA table includes: a first TDRA table and/or a second TDRA table. The first TDRA table is used for indicating time domain resource allocation information of a PDSCH; and the second TDRA table is used for indicating time domain resource allocation information of a PUSCH.

In some embodiments, the configuration case of the TDRA table includes at least one of the following:
the first TDRA table is associated with a PUCCH group;
the second TDRA table is associated with a PUCCH group;
the first TDRA table is associated with a cell group;
the second TDRA table is associated with a cell group;
the first TDRA table is associated with a cell set;
the second TDRA table is associated with a cell set.

In some embodiments, when both the first TDRA table and the second TDRA table are associated with a cell set, the cell set associated with the first TDRA table and the cell set associated with the second TDRA table is same or different.

In some embodiments, the TDRA indication information is transmitted. The TDRA indication information is used for determining, in the TDRA table, the time domain resource allocation information for data channel corresponding to each cell of a set of scheduled cells.

In some embodiments, the TDRA indication information is carried in DCI for scheduling a PDSCH, the TDRA table is a first TDRA table, and the first TDRA table is used for indicating time domain resource allocation information of a PDSCH; and/or
the TDRA indication information is carried in a DCI for scheduling a PUSCH, the TDRA table is a second TDRA table, and the second TDRA table is used for indicating time domain resource allocation information of a PUSCH.

In some embodiments, each piece of time domain resource allocation information for data channel included in the TDRA element corresponds to a cell index of one cell. The first TDRA indication information, and/or a cell index of each cell in the set of scheduled cells is transmitted. The first TDRA indication information has a first value.

In some embodiments, each piece of time domain resource allocation information for data channel included in the TDRA element corresponds to a cell index of one cell. At least one of the second TDRA indication information, a set index of a set of scheduled cells, or a cell index of each cell in the set of scheduled cells is transmitted. The second TDRA indication information has a second value.

In some embodiments, the TDRA element in the TDRA table includes the time domain resource allocation information for data channel of each BWP of each of N cells, where N is the number of cells in the first object. At least one of third TDRA indication information, a cell index of each cell of the set of scheduled cells, or an active BWP index of each cell is transmitted. The third TDRA indication information has a third value.

In some embodiments, the TDRA element in the TDRA table includes the time domain resource allocation information for data channel of each BWP of each of N cells, where N is the number of cells in the first object. At least one of fourth TDRA indication information, a set index of a set of scheduled cells, a cell index of each cell of the set of scheduled cells, or an active BWP index of each cell is transmitted. The fourth TDRA indication information has a fourth value.

In some embodiments, the first indication field of the transmitted DCI carries the set index and/or the cell index of the set of scheduled cells.

At step 730: the PUSCH/PDSCH is received.

The time domain position of the PUSCH/PDSCH corresponds to the time domain resource allocation information indicated by the TDRA instruction information.

In summary, according to the method provided by the embodiments, it facilitates the terminal device to determine the time domain resource allocation information for data channel of each cell by flexibly configuring the TDRA table. Further, since it is supported that the TDRA table is associated with the first object (including at least two cells), in the scenario that one DCI schedules a plurality of PDSCH/PUSCH of a plurality of cells, the configuration requirements of the TDRA tables with different granularities can be met, such that the resource overhead of configuring the TDRA table in the time domain resource allocation process can be saved, and the flexibility and relevance of the configuration and scheduling in the time domain resource allocation process can be significantly improved.

FIG. 8 illustrates a schematic flow diagram of a method for configuring a time domain resource allocation according to an exemplary embodiment of the present disclosure, taking the method being executed by a network device as an example, and the method includes at least some of the following steps.

At step 810: the configuration of at least two TDRA tables is transmitted.

The configuration may be transmitted by the network device through higher layer signaling, and the higher layer signaling includes SIB, RRC, or MAC signaling.

In the present embodiment, the TDRA table is associated with the BWP of each cell, and the TDRA element in the TDRA table includes time domain resource allocation information for data channel of one cell. In some embodiments, the TDRA element in the TDRA table includes the time domain resource allocation information for data channel of one BWP of one cell. The TDRA table includes at least one TDRA element.

In the present embodiments, it is illustratively described with the example that the TDRA table includes a first TDRA table and a second TDRA table. The first TDRA table is used for indicating the time domain resource allocation information of PDSCH, and the second TDRA table is used for indicating the time domain resource allocation information of PUSCH. Each TDRA element in the first TDRA table includes one piece of time domain resource allocation information of PDSCH, and each piece of time domain resource allocation information of PDSCH corresponds to one cell index and one BWP index. Each TDRA element in the second TDRA table includes one piece of time domain resource allocation information of PUSCH, and each piece of time domain resource allocation information of PUSCH corresponds to one cell index and one BWP index.

In some embodiments, the correspondence between the time domain resource allocation information of PDSCH or the time domain resource allocation information of PUSCH and the cell indexes and BWP indexes is predefined through a communication protocol or configured by a network device. For example, the communication protocol predefines that the TDRAs a-b correspond to the cell indexes p-q and BWP indexes 1-3, respectively. Alternatively, the network device configures that the TDRA element 1 includes {cell index x BWP index z, TDRA y}.

Exemplarily, the configuration of the first TDRA table as shown in Table 12 to Table 17 is transmitted.

At step 830: the target TDRA indication information is transmitted.

The time domain resource allocation information for data channel of each cell of a set of scheduled cells is determined in the at least two TDRA tables based on target TDRA indication information.

The scheduled cells include at least two cells, and the at least two cells are at least two of the serving cells.

The target indication information is transmitted by the network device to the terminal device. In some embodiments, the target indication information is carried in the DCI for scheduling the PDSCH, and/or the target indication information is carried in the DCI for scheduling the PUSCH.

In some embodiments, the target indication information has a target value.

In some embodiments, the target value is used for indicating the TDRA element with an element index of n in all received TDRA tables. In some embodiments, the correspondence relationship between the target value and n is configured by the network device through the higher layer signaling, or predefined through the communication protocol. In some embodiments, the correspondence relationship between the target values of different cells or different BWPs and n may be the same or different. For example, the target value is m, which indicates that the n-th row of TDRA elements in the received 64 first TDRA tables, n=m or n=m+1.

In some embodiments, the cell index of each cell of the set of scheduled cells is explicitly indicated by the network device, or implicitly determined based on the set index of the set of scheduled cells. In some embodiments, the cell index is carried in a first indication field of the DCI. In some embodiments, the specific manner of the implicit determination may be predefined through the communication protocol, or configured by the network device.

In some embodiments, the set index of the set of scheduled cells is indicated explicitly by the network device. In some embodiments, the set index is carried in a first indication field of the DCI.

In some embodiments, the BWP index in each cell is indicated explicitly by the network device. Alternatively, the BWP index in each cell is implicitly determined based on the set index of the set of scheduled cells. Alternatively, the BWP index in each cell is implicitly determined based on the cell index of each cell of the set of scheduled cells. Alternatively, the BWP index in each cell is implicitly determined based on the set index of the set of scheduled cells and the cell index of each cell of the set of scheduled cells. In some embodiments, the BWP index is carried in a first indication field of the DCI. In some embodiments, the specific manner of the implicit determination may be predefined through the communication protocol, or configured by the network device.

At step 850: the PUSCH/PDSCH is received.

The time domain position of the PUSCH/PDSCH corresponds to the time domain resource allocation information indicated by the target TDRA instruction information.

In summary, according to the method provided in the present embodiment, the TDRA table is configured in association with the BWP of each cell, it facilitates the terminal device to determine the corresponding TDRA element in the corresponding TDRA table by transmitting the TDRA indication information, such that the accuracy and flexibility of the configuration and scheduling in the time domain resource allocation process are improved.

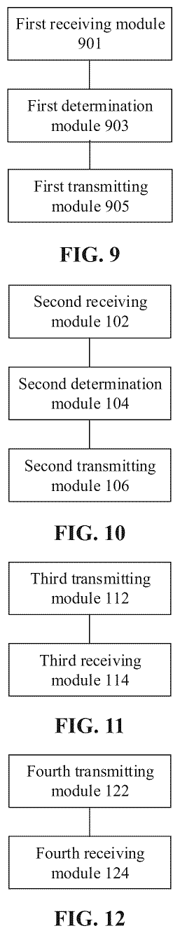

FIG. 9 illustrates a structural block diagram of a device for configuring time domain resource allocation configuration according to an exemplary embodiment of the present disclosure. Taking the device being applied to a terminal device as an example, the device includes at least part of the following: a first receiving module 901, a first determination module 903, and a first transmitting module 905.

The first receiving module is configured to receive a configuration of a TDRA table, herein the TDRA table is associated with a first object, the first object comprises at least two cells, and a TDRA element in the TDRA table comprises time domain resource allocation information for data channel corresponding to each cell in the first object.

In some embodiments, the first object is at least one of:
PUCCH group;
a cell group; or
a cell set.

In some embodiments, each piece of time domain resource allocation information for data channel included in the TDRA element corresponds to a cell index of one cell, and this cell is a cell in the first object.

In some embodiments, each piece of time domain resource allocation information for data channel in the TDRA element corresponds to a cell index of one cell and one BWP index in the cell, and the cell is a cell in the first object.

In some embodiments, the TDRA element in the TDRA table includes the time domain resource allocation information for data channel of each BWP of each of N cells, N is a number of cells in the first object.

In some embodiments, the TDRA table includes:
a first TDRA table and/or a second TDRA table.

The first TDRA table is used for indicating time domain resource allocation information of a PDSCH; and the second TDRA table is used for indicating time domain resource allocation information of a PUSCH.

In some embodiments, the first TDRA table and the second TDRA table are associated with the PUCCH group.

Alternatively, the first TDRA table is associated with the PUCCH group and the second TDRA table is associated with the cell group.

Alternatively, the first TDRA table and the second TDRA table are associated with the cell group.

In some embodiments, the first TDRA table and the second TDRA table are associated with the cell set.

In some embodiments, the first receiving module 901 is further configured to acquire TDRA indication information.

In some embodiments, the device further includes a first determination module 903. The determination module is configured to determine the time domain resource allocation information for data channel corresponding to each cell of a set of scheduled cells is determined in the TDRA table based on the TDRA indication information.

In some embodiments, the TDRA indication information is carried in DCI for scheduling a PDSCH, the TDRA table is a first TDRA table, and the first TDRA table is used for indicating time domain resource allocation information of a PDSCH;
and/or
the TDRA indication information is carried in a DCI for scheduling a PUSCH, the TDRA table is a second TDRA table, and the second TDRA table is used for indicating time domain resource allocation information of a PUSCH.

In some embodiments, each piece of time domain resource allocation information for data channel in the TDRA element corresponds to a cell index of one cell, the cell is a cell in the first object; and the TDRA table is associated with a Physical Uplink Control Channel (PUCCH) group and/or a cell group.

The first determination module 903 is further configured to:
determine time domain resource allocation information for data channel corresponding to each cell of a set of scheduled cells according to a first TDRA element in the TDRA table corresponding to a first value and/or a cell index of the each cell.

The first value is determined based on first TDRA indication information.

In some embodiments, each piece of time domain resource allocation information for data channel in the TDRA element corresponds to a cell index of one cell, the cell is a cell in the first object; and the TDRA table is associated with a cell set.

The first determination module 903 is further configured to:
determine the time domain resource allocation information for data channel corresponding to each cell of a set of scheduled cells according to at least one of: a second TDRA element in the TDRA table corresponding to a second value, a set index of the set of scheduled cells, or a cell index of the each cell.

The second value is determined based on second TDRA indication information.

In some embodiments, each piece of time domain resource allocation information for data channel in the TDRA element corresponds to a cell index of one cell and one BWP index in this cell, the cell is a cell in the first object; and the TDRA table is associated with a Physical Uplink Control Channel (PUCCH) group and/or a cell group.

The first determination module 903 is further configured to:
determine time domain resource allocation information for data channel corresponding to each cell of a set of scheduled cells according to at least one of: a third TDRA element in the TDRA table corresponding to a third value, a cell index of the each cell, or an active BWP index of the each cell.

The third value is determined based on third TDRA indication information.

In some embodiments, each piece of time domain resource allocation information for data channel in the TDRA element corresponds to a cell index of one cell and one BWP index in this cell, the cell is a cell in the first object; and the TDRA table is associated with a cell set.

The first determination module 903 is further configured to:
determine time domain resource allocation information for data channel corresponding to each cell of a set of scheduled cells according to at least one of: a fourth TDRA element in the TDRA table corresponding to a fourth value, a set index of the set of scheduled cells, a cell index of the each cell, or an active BWP index of the each cell.

The fourth value is determined based on fourth TDRA indication information.

In some embodiments, the set index and/or the cell index of the set of scheduled cells is carried in a first indication field of the DCI.

In some embodiments, the device further includes a first transmitting module 905. The transmitting module is configured to transmit a PDSCH/PUSCH. The time domain position of the PDSCH/PUSCH corresponds to the time domain resource allocation information indicated by TDRA indication information.

In summary, according to the device provided by the embodiments, the time domain resource allocation information for data channel of each cell is determined based on the TDRA table flexibly configured. Since the TDRA table is associated with the first object, in the scenario that one DCI schedules a plurality of PDSCH/PUSCH of a plurality of cells, the configuration requirements of the TDRA tables with different granularities can be met, such that the resource overhead of configuring the TDRA table in the time domain resource allocation process can be saved, and the flexibility and relevance of the configuration and indication in the time domain resource allocation process can be significantly improved.

FIG. 10 illustrates a structural block diagram of a device for configuring time domain resource allocation configuration according to an exemplary embodiment of the present disclosure. Taking the device being applied to a terminal device as an example, the device includes at least part of the following modules: a second receiving module 102, a second determination module 104, and a second transmitting module 106.

The second receiving module 102 is configured to receive a configuration of at least two TDRA tables. The TDRA tables are associated with a BWP of each cell, and the TDRA elements in the TDRA tables comprise time domain resource allocation information for data channel of the cell.

The second determination module 104 is configured to determine, in the at least two TDRA tables, time domain resource allocation information for data channel of each cell of a set of scheduled cells based on target TDRA indication information.

The scheduled cells include at least two cells.

In some embodiments, the second determination module 104 is further configured to determine the time domain resource allocation information for data channel corresponding to each cell of a set of scheduled cells according to at least one of: a third TDRA element in the target TDRA table corresponding to a target value, a cell index of the each cell, or an active BWP index of the each cell.
wherein the target value is determined based on the target TDRA indication information.

In some embodiments, the TDRA table includes:
a first TDRA table and/or a second TDRA table.

The first TDRA table is used for indicating time domain resource allocation information of a PDSCH; and the second TDRA table is used for indicating time domain resource allocation information of a PUSCH.

In some embodiments, the target TDRA indication information is carried in the DCI for scheduling a PDSCH, and the TDRA table is the first TDRA table;
and/or
the target TDRA indication information is carried in DCI for scheduling a PUSCH, and the TDRA table is the second TDRA table.

In some embodiments, the device further includes a second transmitting module 106. The transmitting module is configured to transmit a PDSCH/PUSCH. The time domain position of the PDSCH/PUSCH corresponds to the time domain resource allocation information indicated by TDRA indication information.

In summary, according to the device provided in the present embodiment, based on the TDRA table configured in association with the BWP of each cell, the scheduled cell and the active BWP are determined, and the corresponding TDRA element is determined in the corresponding TDRA table based on the TDRA indication information, such that the accuracy and flexibility of the configuration and scheduling in the time domain resource allocation process are improved.

FIG. 11 illustrates a structural block diagram of a device for configuring time domain resource allocation configuration according to an exemplary embodiment of the present disclosure. Taking the device being applied to a network device as an example, the device includes at least part of the following modules: a third transmitting module 112, and a third receiving module 114.

The third transmitting module 112 is configured to transmit a configuration of a TDRA table. The TDRA table is associated with a first object, the first object comprises at least two cells, and a TDRA element in the TDRA table comprises time domain resource allocation information for data channel corresponding to each cell in the first object.

In some embodiments, the first object is at least one of:
PUCCH group;
a cell group; or
a cell set.

In some embodiments, each piece of time domain resource allocation information for data channel in the TDRA element corresponds to a cell index of one cell, and this cell is a cell in the first object.

In some embodiments, each piece of time domain resource allocation information for data channel in the TDRA element corresponds to a cell index of one cell and one BWP index in the cell, and the cell is a cell in the first object.

In some embodiments, the TDRA element in the TDRA table includes the time domain resource allocation information for data channel of each BWP in N cells, N is a number of cells in the first object.

In some embodiments, the TDRA table includes:
a first TDRA table and/or a second TDRA table.

The first TDRA table is used for indicating time domain resource allocation information of a PDSCH; and the second TDRA table is used for indicating time domain resource allocation information of a PUSCH.

In some embodiments, the first TDRA table and the second TDRA table are associated with the PUCCH group.

Alternatively, the first TDRA table is associated with the PUCCH group and the second TDRA table is associated with the cell group.

Alternatively, the first TDRA table and the second TDRA table are associated with the cell group.

In some embodiments, the first TDRA table and the second TDRA table are associated with the cell set.

In some embodiments, the third transmitting module 112 is further configured to transmit the TDRA indication information. The TDRA indication information is used for determining, in the TDRA table, the time domain resource allocation information for data channel corresponding to each cell of a set of scheduled cells.

In some embodiments, the TDRA indication information is carried in DCI for scheduling a PDSCH, the TDRA table is a first TDRA table, and the first TDRA table is used for indicating time domain resource allocation information of a PDSCH;
and/or
the TDRA indication information is carried in a DCI for scheduling a PUSCH, the TDRA table is a second TDRA table, and the second TDRA table is used for indicating time domain resource allocation information of a PUSCH.

In some embodiments, each piece of time domain resource allocation information for data channel in the TDRA element corresponds to a cell index of one cell, the cell is a cell in the first object; and the TDRA table is associated with a Physical Uplink Control Channel (PUCCH) group and/or a cell group.

The third transmitting module 112 is further configured to transmit first TDRA indication information and/or a cell index of each cell of a set of scheduled cells.

The first TDRA indication information has a first value.

In some embodiments, each piece of time domain resource allocation information for data channel in the TDRA element corresponds to a cell index of one cell, the cell is a cell in the first object; and the TDRA table is associated with a cell set.

The third transmitting module 112 is further configured to transmit at least one of: second TDRA indication information, a set index of a set of scheduled cells, or a cell index of each cell of the set of scheduled cells.

The second TDRA indication information has a second value.

In some embodiments, each piece of time domain resource allocation information for data channel in the TDRA element corresponds to a cell index of one cell and one BWP index in this cell, the cell is a cell in the first object; and the TDRA table is associated with a Physical Uplink Control Channel (PUCCH) group and/or a cell group.

The third transmitting module 112 is further configured to transmit at least one of: third TDRA indication information, a cell index of each cell of a set of scheduled cells, or an active BWP index of the each cell.

The third TDRA indication information has a third value.

In some embodiments, each piece of time domain resource allocation information for data channel in the TDRA element corresponds to a cell index of one cell and one BWP index in this cell, the cell is a cell in the first object; and the TDRA table is associated with a cell set.

The third transmitting module 112 is further configured to transmit at least one of: fourth TDRA indication information, the set indexi of a set of scheduled cells, a cell index of each cell of the set of scheduled cells, or an active BWP index of the each cell.

The fourth TDRA indication information has a fourth value.

In some embodiments, the first indication field of the DCI carries the set index and/or the cell index of the set of scheduled cells.

In some embodiments, the device further includes the third receiving module 114. The third receiving module is configured to receive the PUSCH/PDSCH. The time domain position of the PUSCH/PDSCH corresponds to the time domain resource allocation information indicated by TDRA indication information.

In summary, according to the device provided by the embodiments, it facilitates the terminal device to determine the time domain resource allocation information for data channel of each cell by flexibly configuring the TDRA table. Further, since it is supported that the TDRA table is associated with the first object, in the scenario that one DCI schedules a plurality of PDSCH/PUSCH of a plurality of cells, the configuration requirements of the TDRA tables with different granularities can be met, such that the resource overhead of configuring the TDRA table in the time domain resource allocation process can be saved, and the flexibility and relevance of the configuration and scheduling in the time domain resource allocation process can be significantly improved.

FIG. 12 illustrates a structural block diagram of a device for configuring time domain resource allocation configuration according to an exemplary embodiment of the present disclosure. Taking the device being applied to a network device as an example, the device includes at least part of the following modules: a fourth transmitting module 122, and a fourth receiving module 124.

The fourth transmitting module 122 is configured to transmit a configuration of at least two TDRA tables. The TDRA tables are associated with a BWP of each cell, and the TDRA elements in the TDRA tables comprise time domain resource allocation information for data channel of the cell.

The fourth transmitting module 122 is further configured to transmit the target TDRA indication information, wherein the target TDRA indication information is used for determining, in the at least two TDRA tables, time domain resource allocation information for data channel of each cell of a set of scheduled cells.

The scheduled cells include at least two cells.

In some embodiments, the fourth transmitting module 122 is further configured to transmit at least one of: a cell index of each cell of the set of scheduled cells, or an active BWP index of the each cell, or the target TDRA indication information.

The target TDRA indication information has a target value.

In some embodiments, the TDRA table includes:
a first TDRA table and/or a second TDRA table.

The first TDRA table is used for indicating time domain resource allocation information of a PDSCH; and the second TDRA table is used for indicating time domain resource allocation information of a PUSCH.

In some embodiments, the target TDRA indication information is carried in the DCI for scheduling a PDSCH, and the TDRA table is the first TDRA table;
and/or
the target TDRA indication information is carried in DCI for scheduling a PUSCH, and the TDRA table is the second TDRA table.

In some embodiments, the device further includes the fourth receiving module 124. The fourth receiving module is configured to receive the PUSCH/PDSCH. The time domain position of the PUSCH/PDSCH corresponds to the time domain resource allocation information indicated by the target TDRA indication information.

In summary, according to the device provided in the present embodiment, the TDRA table is configured in association with the BWP of each cell, it facilitates the terminal device to determine the corresponding TDRA element in the corresponding TDRA table by transmitting the TDRA indication information, such that the accuracy and flexibility of the configuration and scheduling in the time domain resource allocation process are improved.

It is to be noted that the devices provided in the above-mentioned embodiments are only illustrated by way of example of the division of the above-mentioned functional modules, and in practical application, the above-mentioned functions may be allocated by different functional modules according to the requirements. That is, the internal structures of the device may be divided into different functional modules to complete all or part of the above-mentioned functions.

With regard to the devices in the present embodiments, the specific manner in which the various modules perform operations has been described in detail in the embodiments related to the method, and will not be described in detail here.

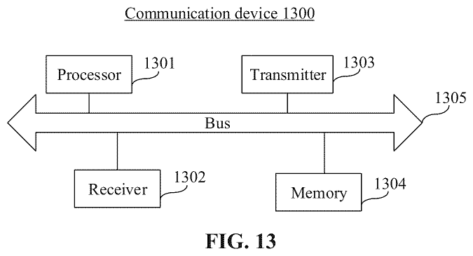

FIG. 13 illustrates a schematic structural diagram of a device (terminal device or network device) for configuring time domain resource allocation according to an exemplary embodiment of the present disclosure. The device 1300 for configuring time domain resource allocation includes: a processor 1301, a receiver 1302, a transmitter 1303, a memory 1304, and a bus 1305.

The processor 1301 includes one or more processing cores, and the processor 1301 is configured to execute various functional applications and information processing by running the software programs and modules. In some embodiments, the processor 1301 may be configured to implement the functions and steps of the first determination module 903 and/or the second determination module 104 described above.

The receiver 1302 and the transmitter 1303 may be implemented as a communication component, which may be a communication chip. In some embodiments, the receiver 1302 may be used to implement the functions and steps of the first receiving module 901 and/or the second receiving module 102 as described above. In some embodiments, the transmitter 1303 may be used to implement the functions and steps of the third transmitting module 112 and/or the fourth transmitting module 122 as described above.

The memory 1304 is connected to the processor 1301 via a bus 1305. The memory 1304 may be configured to store at least one instruction, and the processor 1301 is configured to execute the instruction to implement various steps in the above-mentioned method embodiments.

Further, the memory 1304 may be implemented by any type of volatile or non-volatile storage devices or the combination thereof. The volatile or non-volatile storage device includes, but not limited to, magnetic or optical disks, Electrically Erasable Programmable Read Only Memory (EEPROM), Erasable Programmable Read-Only Memory (EPROM), Static Random-Access Memory (SRAM), Read-Only Memory (ROM), Magnetic Memory, Flash Memory, and Programmable Read-Only Memory (PROM).

In some embodiments, the receiver 1302 receives the signal/data independently, or the processor 1301 controls the receiver 1302 to receive the signal/data, or the processor 1301 requests the receiver 1302 to receive the signal/data, or the processor 1301 cooperates with the receiver 1302 to receive the signal/data.

In some embodiments, the transmitter 1303 transmits the signal/data independently, or the processor 1301 controls the transmitter 1303 to transmit the signal/data, or the processor 1301 requests the transmitter 1303 to transmit the signal/data, or the processor 1301 cooperates with the transmitter 1303 to transmit the signal/data.

In an exemplary embodiment, there is further provided a computer-readable storage medium having stored thereon an executable program. The executable program is loaded and executed by a processor of a communication device to implement the method for configuring time domain resource allocation provided in various optional implementations as described in the above aspects.

In an exemplary embodiment, there is also provided a chip. The chip includes a programmable logic circuit or a program, and a communication device installed with the chip is configured to implement the method for configuring time domain resource allocation provided in various optional implementations as described in the above aspects.

In an exemplary embodiment, there is also provided a computer program product. The computer program product includes a computer program. The computer program is stored in a computer-readable storage medium. The processor of a communication device reads the computer program from the computer-readable storage medium, and the processor executes the computer program such that the communication device performs the method for configuring time domain resource allocation provided in various optional implementations described in the above aspects.

According to an aspect of the present disclosure, there is provided a computer program. The computer includes the computer instructions which, when executed by a processor of a computer device, cause the computer device to perform the method for configuring time domain resource allocation provided in various optional implementations in the above aspects.

It is to be noted by those skilled in the art that in one or more of the examples described above, the functions described in the embodiments of the present disclosure may be implemented in hardware, software, firmware, or any combination thereof. When implemented by using the software, these functions may be stored in a computer-readable medium or transmitted as one or more instructions or code on a computer-readable medium. The computer-readable medium includes the computer storage medium and the communication medium. The communication medium includes any medium that facilitates the transfer of a computer program from one place to another place. The storage medium may be any available medium that can be accessed by a general-purpose or special-purpose computer.

The descriptions above are only optional embodiments of the present disclosure, and are not intended to limit the present disclosure. Any modification, equivalent replacement and improvement made within the spirit and principles of the present disclosure all fall within the protection scope of the present disclosure.

1. A terminal device, comprising:
a processor; and
a transceiver coupled with the processor; and
a memory for storing an executable program for the processor;
wherein the processor is configured to load and execute the executable program to perform an operation of:
receiving a configuration of a time domain resource allocation (TDRA) table, wherein the TDRA table is associated with a first object, the first object comprises at least two cells, and a TDRA element in the TDRA table comprises time domain resource allocation information for data channel corresponding to each cell in the first object.

2. The terminal device of claim 1, wherein the first object is at least one of:
a Physical Uplink Control Channel (PUCCH) group;
a cell group; or
a cell set.

3. The terminal device of claim 2, wherein
each piece of time domain resource allocation information for data channel in the TDRA element corresponds to a cell index of one cell and one bandwidth part (BWP) index in the cell, and the cell is a cell in the first object.

4. The terminal device of claim 3, wherein
the TDRA element comprises time domain resource allocation information for data channel of each BWP of each of N cells, and N is a number of cells in the first object.

5. The terminal device of claim 4, wherein
the correspondence between the time domain resource allocation information for the data channels corresponding to the N cells in the TDRA element and the N cells is that: the time domain resource allocation information for the data channels corresponding to the N cells in the TDRA element is placed according to an ascending order of a cell index of the N cells; and
the correspondence between the time domain resource allocation information for the data channels corresponding to each BWP of each cell in the TDRA element and the BWPs within the cell is that: the time domain resource allocation information for the data channels corresponding to each BWP of each cell in the TDRA element is placed according to an ascending order of a BWP index of the BWPs within the cell.

6. The terminal device of claim 3, wherein the TDRA table comprises:
a first TDRA table and/or a second TDRA table;
wherein the first TDRA table is used for indicating time domain resource allocation information of Physical Downlink Shared Channel (PDSCH); and the second TDRA table is used for indicating time domain resource allocation information of PUSCH.

7. The terminal device of claim 6, wherein
the first TDRA table and the second TDRA table are associated with the cell set.

8. The terminal device of claim 1, wherein the processor is further configured to load and execute the executable program to perform operations of:
obtaining TDRA indication information; and
determining, in the TDRA table, time domain resource allocation information for data channel corresponding to each cell of a set of scheduled cells based on the TDRA indication information.

9. The terminal device of claim 8, wherein
the TDRA indication information is carried in Downlink Control Information (DCI) for scheduling a Physical Downlink Shared Channel (PDSCH), the TDRA table is a first TDRA table, and the first TDRA table is used for indicating time domain resource allocation information of PDSCH; and/or
the TDRA indication information is carried in a DCI for scheduling a Physical Uplink Shared Channel (PUSCH), the TDRA table is a second TDRA table, and the second TDRA table is used for indicating time domain resource allocation information of PUSCH.

10. The terminal device of claim 1, wherein each piece of time domain resource allocation information for data channel in the TDRA element corresponds to a cell index of one cell and one bandwidth part (BWP) in the cell, the cell is a cell in the first object; and the TDRA table is associated with a cell set; and
wherein the processor is further configured to load and execute the executable program to perform an operation of:
determining time domain resource allocation information for data channel corresponding to each cell of a set of scheduled cells according to at least one of: a fourth TDRA element in the TDRA table, a set index of the set of scheduled cells, a cell index of the each cell, or an active BWP index of the each cell, wherein the fourth TDRA element corresponds to a fourth value;
wherein the fourth value is determined based on fourth TDRA indication information.

11. The terminal device of claim 8, wherein a set index and/or a cell index of the set of scheduled cells are carried in a first indication field of Downlink Control Information (DCI).

12. A network device, comprising:
a processor; and
a transceiver coupled with the processor; and
a memory for storing an executable program for the processor;
wherein the processor is configured to load and execute the executable program to perform an operation of:
transmitting a configuration of a time domain resource allocation (TDRA) table, wherein the TDRA table is associated with a first object, the first object comprises at least two cells, and a TDRA element in the TDRA table comprises time domain resource allocation information for data channel corresponding to each cell in the first object.

13. The network device of claim 12, wherein the first object is at least one of:
a Physical Uplink Control Channel (PUCCH) group;
a cell group; or
a cell set.

14. The network device of claim 13, wherein
each piece of time domain resource allocation information for data channel in the TDRA element corresponds to a cell index of one cell and one bandwidth part (BWP) index in the cell, and the cell is a cell in the first object.

15. The network device of claim 14, wherein
the TDRA element in the TDRA table comprises time domain resource allocation information for data channel of each BWP in N cells, and N is a number of cells in the first object.

16. The network device of claim 14, wherein the TDRA table comprises:
a first TDRA table and/or a second TDRA table;
wherein the first TDRA table is used for indicating time domain resource allocation information of a Physical Downlink Shared Channel (PDSCH); and the second TDRA table is used for indicating time domain resource allocation information of a Physical Uplink Control Channel (PUSCH).

17. The network device of claim 16, wherein
the first TDRA table and the second TDRA table are associated with the cell set.

18. The network device of claim 12, wherein the processor further is configured to load and execute the executable program to perform an operation of:
transmitting TDRA indication information, wherein the TDRA indication information is used for determining, in the TDRA table, time domain resource allocation information for data channel corresponding to each cell of a set of scheduled cells.

19. The network device of claim 18, wherein
the TDRA indication information is carried in Downlink Control Information (DCI) for scheduling a Physical Downlink Shared Channel (PDSCH), the TDRA table is a first TDRA table, and the first TDRA table is used for indicating time domain resource allocation information of PDSCH; and/or
the TDRA indication information is carried in DCI for scheduling a Physical Uplink Shared Channel (PUSCH), the TDRA table is a second TDRA table, and the second TDRA table is used for indicating time domain resource allocation information of PUSCH.

20. The network device of claim 12, wherein each piece of time domain resource allocation information for data channel in the TDRA element corresponds to a cell index of one cell and one bandwidth part (BWP) in the cell, the cell is a cell in the first object; and the TDRA table is associated with a cell set; and
wherein the processor further is configured to load and execute the executable program to perform an operation of:
transmitting at least one of: fourth TDRA indication information, a set index of a set of scheduled cells, a cell index of each cell of the set of scheduled cells, or an active BWP index of the each cell;
wherein the fourth TDRA indication information has a fourth value.
